(19) United States
(12) Patent Application Publication
(10) Pub. No.: US 2012/0286174 A1
(43) Pub. Date: Nov. 15, 2012

(54) CHARGED PARTICLE BEAM WRITING APPARATUS AND CHARGED PARTICLE BEAM WRITING METHOD

(75) Inventors: Saori GOMI, Kanagawa (JP); Hitoshi Higurashi, Kanagawa (JP)

(73) Assignee: NuFlare Technology, Inc., Numazu-shi (JP)

(21) Appl. No.: 13/461,137

(22) Filed: May 1, 2012

(30) Foreign Application Priority Data
May 12, 2011 (JP) 2011-107082
Nov. 30, 2011 (JP) 2011-261563

(51) Int. Cl. G21K 5/00

(52) U.S. Cl. 250/492.3

(57) ABSTRACT

A writing apparatus wherein, for each figure pattern representative of a chip, the figure patterns are divided into shot figures represented by shot division image information for discriminating a size of each of the shot figures and an arrangement position in each of the figure patterns of each of the shot figures. Using the shot division image information and information on alignment coordinates of each of the figure patterns, an allotting processing unit allots each of the shot figures to be arranged in each of mesh regions virtually divided by a predetermined size from a reference position different from an end portion of a figure pattern concerned in a chip region. For each of the mesh regions, there is calculated a number of shots of the beam used when writing inside of a mesh region concerned based on the number of allotted shot figures.

### CROSS-REFERENCE TO RELATED APPLICATION

This application is based upon and claims the benefit of priority from the prior Japanese Patent Application No. 2011-107082 filed on May 12, 2011 in Japan, and the prior Japanese Patent Application No. 2011-261563 filed on Nov. 30, 2011 in Japan, the entire contents of which are incorporated herein by reference.

### BACKGROUND OF THE INVENTION

1. Field of the Invention

The present invention relates to a charged particle beam writing apparatus and a charged particle beam writing method, and, for example, it relates to an apparatus and a method for writing that can estimate the number of shots used for predicting a writing time and an area density used for performing dose correction calculation.

2. Description of Related Art

The lithography technique that advances microminiaturization of semiconductor devices is extremely important as being a unique process whereby patterns are formed in the semiconductor manufacturing. In recent years, with high integration of LSI, the line width (critical dimension) required for semiconductor device circuits is decreasing year by year. In order to form a desired circuit pattern on semiconductor devices, a master or “original” pattern (also called a mask or a reticle) of high precision is needed. Thus, the electron beam writing technique, which intrinsically has excellent resolution, is used for producing such a highly precise master pattern.

FIG. 10 is a schematic diagram explaining operations of a variable shaped electron beam (EB) writing apparatus. As shown in the figure, the variable shaped electron beam writing apparatus operates as described below. A first aperture plate 410 has a quadrangular opening 411 for shaping an electron beam 330. A second aperture plate 420 has a variable-shape opening 421 for shaping the electron beam 330 having passed through the opening 411 of the first aperture plate 410 into a desired quadrangular shape. The electron beam 330 emitted from a charged particle source 430 and having passed through the opening 411 is deflected by a deflector to pass through a part of the variable-shape opening 421 of the second aperture plate 420, and thereby to irradiate a target workpiece or “sample” 340 placed on a stage which continuously moves in one predetermined direction (e.g. x direction) during the writing. In other words, a quadrangular shape that can pass through both the opening 411 and the variable-shape opening 421 is used for pattern writing in a writing region of the target workpiece 340 on the stage continuously moving in the x direction. This method of forming a given shape by letting beams pass through both the opening 411 of the first aperture plate 410 and the variable-shape opening 421 of the second aperture plate 420 is referred to as a variable shaped beam (VSB) method.

When writing a chip pattern by a writing apparatus, the time for writing the chip pattern is predicted and the predicted time is provided for the user (refer to, e.g., Japanese Patent Application Laid-open (JP-A) No. 2009-088213). Therefore, it is necessary to estimate the number of shots to be used for writing the chip pattern. Conventionally, as for the chip pattern writing, a chip region is divided into a plurality of mesh regions. Moreover, the region of each of cells configuring a chip is divided into mesh regions. Furthermore, each figure pattern in a cell is also divided into mesh regions.

### BRIEF SUMMARY OF THE INVENTION

In accordance with one aspect of the present invention, a charged particle beam writing apparatus includes a storage unit configured to store chip data in which there is defined each figure pattern data indicating a shape, alignment coordinates, and a size of each of a plurality of figure patterns included in a chip, a shot division image information generation unit configured to input the each figure pattern data in the chip data, and for the each of the plurality of figure patterns, when the each of the plurality of figure patterns is divided into a plurality of shot figures each having a size to be irradiated with one shot of a charged particle beam, to generate shot division image information for discriminating a size of each of the plurality of shot figures and an arrangement position in the each of the plurality of figure patterns of the each of the plurality of shot figures, an allotting processing unit configured, by using the shot division image information and information on alignment coordinates of the each of the plurality of figure patterns, to allot the each of the plurality of shot figures to be arranged in each of a plurality of mesh regions virtually divided by a predetermined size from a reference position different from an end portion of a figure pattern concerned in a chip region concerned indicated by the chip data, a shot number calculation unit configured, for the each of the plurality of mesh regions, to calculate a number of shots of the charged particle beam used when writing inside of a mesh region concerned based on a number of allotted shot figures, a writing time prediction unit configured to predict a writing time for writing a chip concerned based on the number of shots for the each of the plurality of mesh regions, and a writing unit configured to write a pattern in the chip concerned on a target workpiece, using the charged particle beam.

In accordance with another aspect of the present invention, a charged particle beam writing method includes inputting each figure pattern data in chip data, from a storage unit storing the chip data in which there is defined the each figure pattern data indicating a shape, alignment coordinates, and a size of each of a plurality of figure patterns included in a chip, and generating, for the each of the plurality of figure patterns, when the each of the plurality of figure patterns is divided into a plurality of shot figures each having a size to be irradiated with one shot of a charged particle beam, shot division image information for discriminating a size of each of the plurality of shot figures and an arrangement position in the each of the plurality of figure patterns of the each of the plurality of shot figures, allotting, by using the shot division image information and information on alignment coordinates of the each of the plurality of figure patterns, the each of the plurality of shot figures to be arranged in each of a plurality of mesh regions virtually divided by a predetermined size from a reference position different from an end portion of a figure pattern concerned in a chip region concerned indicated by the chip data, calculating, for the each of the plurality of mesh regions, a number of shots of the charged particle beam used when writing inside of a mesh region concerned based on a number of allotted shot figures, predicting a writing time for writing a chip concerned based on the number of shots for the each of the plurality of mesh regions, and writing a pattern in the chip concerned on a target workpiece, using the charged particle beam.

### BRIEF DESCRIPTION OF THE DRAWINGS

FIG. 1 is a schematic diagram showing a structure of a writing apparatus according to Embodiment 1;

FIG. 2 is a schematic diagram showing an example of a figure pattern and a divided cell region in a cell according to Embodiment 1;

FIGS. 3A and 3B are schematic diagrams showing an example of shot division image information according to Embodiment 1;

FIG. 4 is a schematic diagram explaining allotting processing with respect to a divided cell region according to Embodiment 1;

FIGS. 5A and 5B are schematic diagrams showing an example of shot division image information according to Embodiment 2;

FIGS. 6A and 6B are schematic diagrams showing another example of shot division image information according to Embodiment 2;

FIGS. 7A and 7B are schematic diagrams showing an example of an original figure to be divided into shot figures and shot division image information thereon according to Embodiment 3;

FIGS. 8A and 8B are schematic diagrams showing another example of an original figure to be divided into shot figures and shot division image information thereon according to Embodiment 3;

FIGS. 9A and 9B are schematic diagrams showing another example of an original figure to be divided into shot figures and shot division image information thereon according to Embodiment 3;

FIG. 10 is a schematic diagram explaining operations of a variable shaped electron beam writing apparatus;

FIGS. 11A and 11B show an example of a method of dividing a region, to be compared with Embodiment 1;

FIG. 12 is a schematic diagram showing an example of a method of estimating the number of shots and a pattern density, to be compared with Embodiment 1; and

FIGS. 13A to 13C are schematic diagrams explaining problems in the cases of dividing and not dividing into the divided pattern regions, to be compared with Embodiment 1.

### DETAILED DESCRIPTION OF THE INVENTION

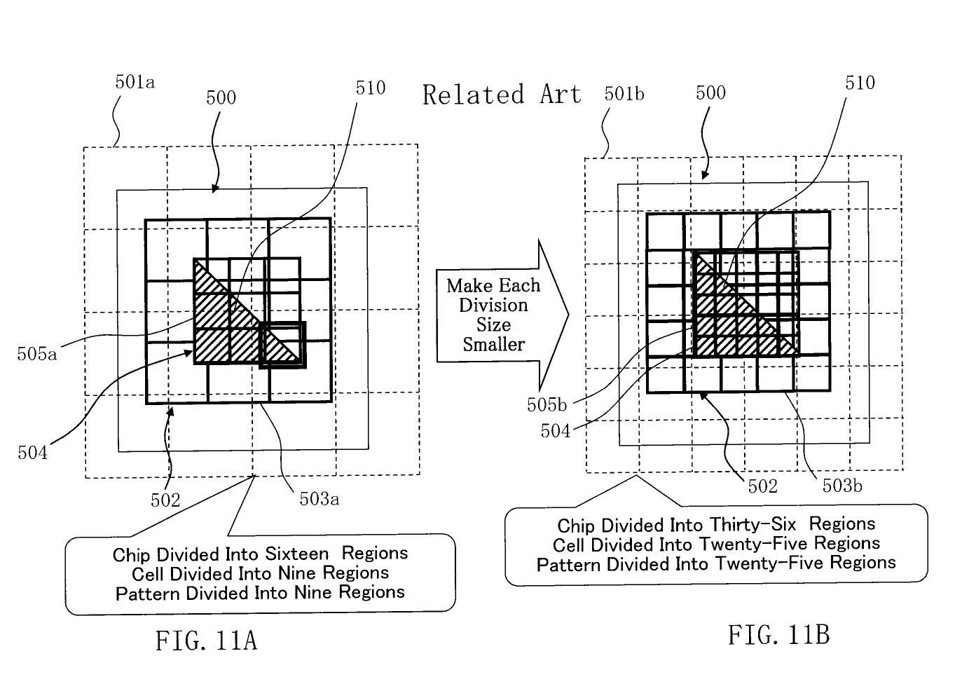

FIGS. 11A and 11B show an example of a method of dividing a region, to be compared with Embodiment 1. In FIGS. 11A and 11B, a chip 500 is divided into a plurality of mesh-like divided chip regions 501a. In the case that the object to be divided is one chip, the chip region concerned is divided into the divided chip regions 501a. In the case that the object is composed of merged chips, the virtual chip region being a circumscribing quadrangular region of the merged chips is divided into the divided chip regions 501a. Here, to facilitate understanding the contents, only one chip in the virtual chip is shown in the figure. Moreover, with respect to a cell 502 in the chip, the region of the cell 502 is divided into a plurality of mesh-like divided cell regions 503a. Furthermore, with respect to a figure pattern 510, a circumscribing quadrangular region 504 of the figure pattern 510 is divided into a plurality of mesh-like divided pattern regions 505a. Generally, the dividing is performed for the divided cell region 503a to be larger than the divided pattern region 505a, and for the divided chip region 501a to be larger than the divided cell region 503a. In electron beam writing, since the size of beam formed by one beam shot is limited, a desired figure pattern is formed by a plurality of shots so as to connect shaped beams. The divided pattern region 505a is configured to be an integral multiple of the maximum shootable shot size. The number of shots for the whole chip is estimated while making the region size larger in order. First, the number of shots for each divided pattern region 505a is estimated. Next, the number of shots for each divided cell region 503a is estimated. Then, the number of shots for each divided chip region 501a is estimated. Moreover, the area density of a pattern in each region is similarly estimated.

With the recent tendency to miniaturization and high density of patterns, the division size of each hierarchical region needs to be small in order to make a calculation result high accurate in each mesh region. As shown in FIG. 11B, the chip 500 is divided into a plurality of mesh-like divided chip regions 501b each being smaller than each of the divided chip region 501a. Moreover, the cell 502 in the chip is divided into a plurality of mesh-like divided cell regions 503b each being smaller than each of the divided cell region 503a. Furthermore, with respect to the figure pattern 510, the circumscribing quadrangular region 504 of the figure pattern 510 is divided into a plurality of mesh-like divided pattern regions 505b each being smaller than each of the divided pattern region 505a. Therefore, in the case of FIGS. 11A and 11B, the number of the divided chip regions 501 increases from sixteen regions to thirty-six regions, the number of the divided cell regions 503 increases from nine regions to twenty-five regions, and the number of the divided pattern regions 505 increases from nine regions to twenty-five regions. Thus, when the division size becomes small, the number of regions increases, and therefore, the number of times of calculation increases, thereby as a whole increasing the processing time for calculating the number of shots and an area density. Accordingly, there is a problem that the writing time increases.

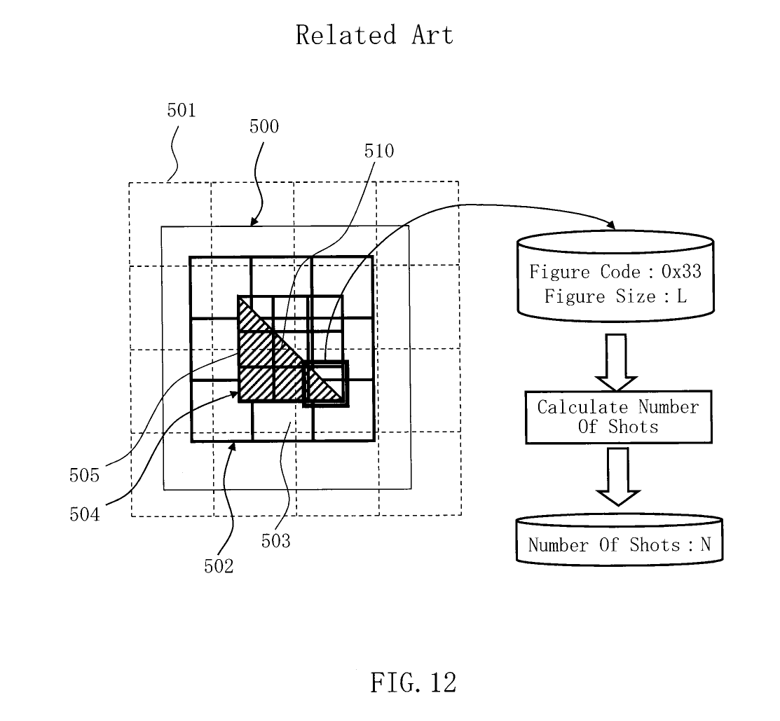

FIG. 12 is a schematic diagram showing an example of a method of estimating the number of shots and a pattern density, to be compared with Embodiment 1. Conventionally, the figure in the region is allotted to each divided pattern region 505 having been divided in meshes to have a size of an integral multiple of the maximum shot size. Then, also conventionally, the following processing has been performed: The figure code and the figure size of the figure in the divided pattern region 505 are transmitted to a shot number calculation function. Then, in each divided pattern region 505, by using the shot number calculation function, the figure is further divided into figures each being of a shot size, and the number of shots in the divided pattern region 505 is calculated. When information on the number of shots in each divided pattern region 505 is acquired, the divided pattern region 505 is allotted to the divided cell region 503 in order to sum up the number of shots and the pattern density of each divided pattern region 505. Then, the divided cell region 503 is allotted to the divided chip region 501 in order to sum up the number of shots and the pattern density of each divided chip region 501.

As described above, there is a problem that the calculation processing time increases when the division size of the region in each hierarchy is made to be small with the recent tendency to miniaturization and high density of patterns. Then, without dividing into the divided pattern region 505, the figure in the region is allotted to each divided cell region 503 at the stage of the cell region 503. It is examined to transmit the figure code and the figure size of the figure in the divided cell region 503 to the shot number calculation function and to divide the figure into figures of a shot size to be beam-shaped in the shot number calculation function in order to omit the calculation processing in the divided pattern region 505. This aims to shorten the processing time as a whole. However, in the case of not dividing into the divided pattern regions 505, the following problem will occur.

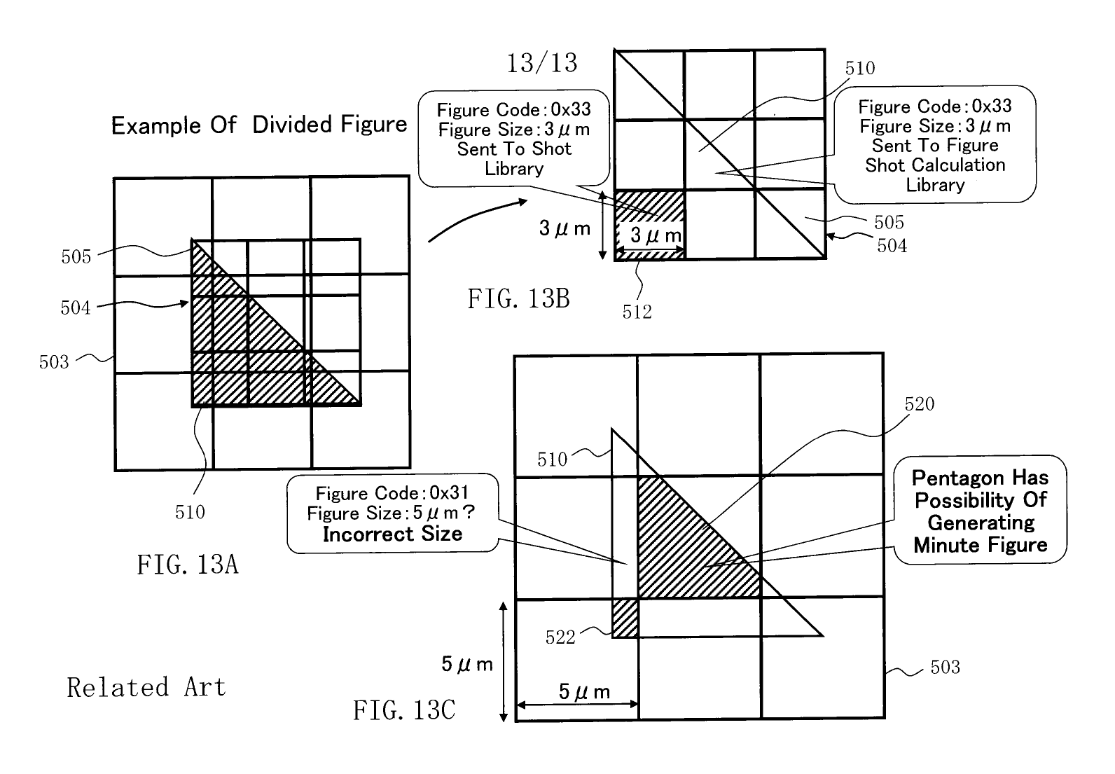

FIGS. 13A to 13C are schematic diagrams explaining problems in the cases of dividing and not dividing into the divided pattern regions, to be compared with Embodiment 1. FIG. 13A shows a plurality of divided cell regions 503 made by dividing the cell region into meshes and a plurality of divided pattern regions 505 made by dividing the circumscribing quadrangular region 504 of the figure pattern 510 into meshes. When outputting the figure code and the size of the figure in the region to the shot number calculation function, the figure size being output is a division size of each region. In the case of dividing into divided pattern regions, as shown in FIG. 13B, the divided pattern region 505 is generated by dividing into meshes each having a size of an integral multiple of the maximum shot size, for example, 3 μm, from the end portion of the figure pattern 510. Therefore, in each divided pattern region 505, a FIG. 512 of the same size as the divided pattern region 505 is arranged. That is, when outputting the size of the divided pattern region 505 to the shot number calculation function, it accords with the size of the FIG. 512. On the other hand, in the case of not dividing into the divided pattern regions, as shown in FIG. 13C, the divided cell region 503 is generated by dividing into meshes each having a size sufficiently longer than the maximum shot size, for example, 5 μm, not from the end portion of the figure pattern but from the end portion of the cell. Therefore, a FIG. 522 smaller than the size of the divided cell region 503 is allotted to the divided cell region 503. Accordingly, if the size of the divided cell region 503 is output as the size of the FIG. 512 to the shot number calculation function, it differs from the size of the actual figure. As a result, when further dividing the figure allotted by the shot number calculation function into figures of a shot size, there occurs a problem that the figure is divided based on an erroneous size. Furthermore, if the figure is allotted to the divided cell region 503, as shown in FIG. 13C, there is a case of generating a pentagonal FIG. 520, for example. However, generally, in the variable shaped electron beam writing apparatus, it is often configured capable of shaping only limited figures such as a quadrangle (e.g., a square and a rectangle), an isosceles right triangle, or a trapezoid composed of angles each being an integral multiple of 45 degrees. Therefore, for example, if the pentagonal FIG. 520 has been generated, when dividing the figure into shot figures by the shot number calculation function, the divided figures may be minute figures sufficiently smaller than the figure of the maximum shot size because the figure is divided into limited figures stated above. Consequently, there occurs a problem that it becomes difficult to calculate the accurate number of shots. Therefore, when transmitting figure information to the shot number calculation function, it is preferable to avoid as much as possible figure shapes that are easily apt to become minute figures.

In the following Embodiments, there will be described a writing apparatus and method whereby a figure is not divided into shot figures of an erroneous size and generation of minute figures is suppressed even when not setting a division region further up to a divided pattern region.

In the following Embodiments, there will be described a structure in which an electron beam is used as an example of a charged particle beam. The charged particle beam is not limited to the electron beam, and other charged particle beam, such as an ion beam, may also be used. Moreover, a variable-shaped electron beam writing apparatus will be described as an example of a charged particle beam apparatus.

### Embodiment 1

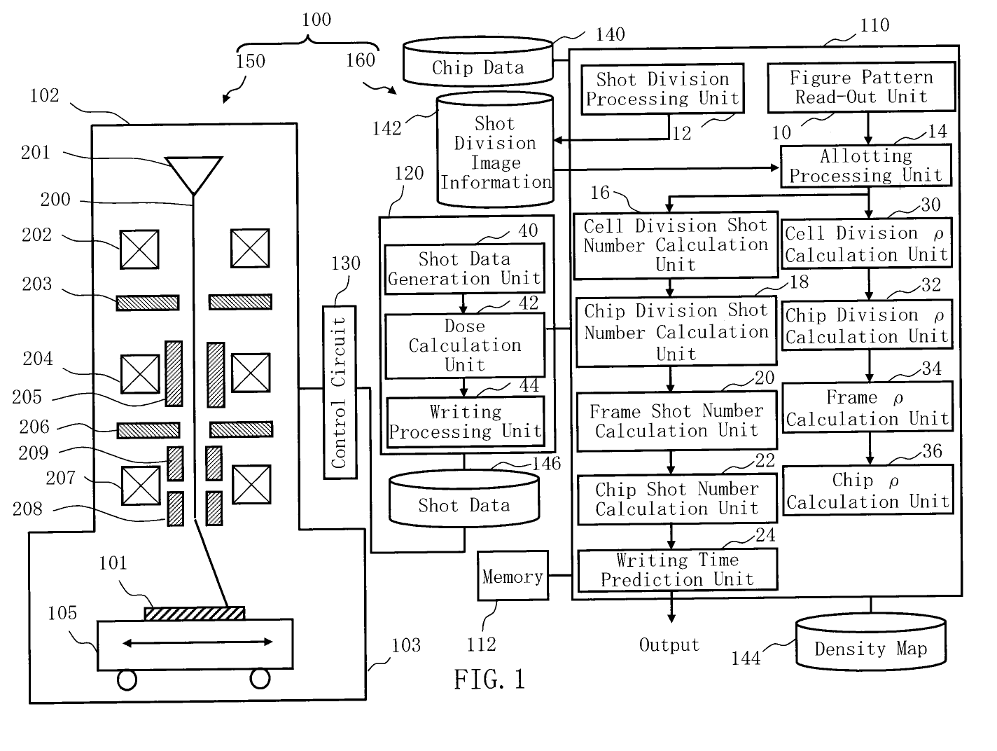

FIG. 1 is a schematic diagram showing a structure of a writing or “drawing” apparatus according to Embodiment 1. In FIG. 1, a writing apparatus 100 includes a writing unit 150 and a controlling unit 160. The writing apparatus 100 is an example of a charged particle beam writing apparatus, and especially, an example of a variable-shaped electron beam writing apparatus. The writing unit 150 includes an electron lens barrel 102 and a writing chamber 103. In the electron lens barrel 102, there are arranged an electron gun 201, an illumination lens 202, a first aperture plate 203, a projection lens 204, a deflector 205, a second aperture plate 206, an objective lens 207, a main deflector 208, and a sub deflector 209. In the writing chamber 103, there is arranged an XY stage 105, on which a target workpiece 101, such as a mask, serving as a writing target is placed. The target workpiece 101 is, for example, a mask for exposure used for manufacturing semiconductor devices, or a mask blank on which resist has been coated and no pattern has yet been formed.

The control unit 160 includes control computers 110 and 120, a memory 112, a control circuit 130, and storage devices 140, 142, 144, and 146, such as a magnetic disk drive. The control computers 110 and 120, the memory 112, the control circuit 130, and the storage devices 140, 142, 144, and 146 are mutually connected through a bus (not shown).

In the control computer 110, there are arranged a figure pattern read-out unit 10, a shot division processing unit 12, an allotting processing unit 14, a cell division shot number calculation unit 16, a chip division shot number calculation unit 18, a frame shot number calculation unit 20, a chip shot number calculation unit 22, a writing time prediction unit 24, a cell division pattern density calculation unit 30, a chip division pattern density calculation unit 32, a frame pattern density calculation unit 34, and a chip pattern density calculation unit 36. Functions of the units described above may be configured by hardware such as an electronic circuit or by software such as a program executing these functions. Alternatively, they may be configured by a combination of hardware and software. Information input/output from/to the units described above and information being calculated are stored in the memory 112 each time.

In the control computer 120, there are arranged a shot data generation unit 40, a dose calculation unit 42, and a writing processing unit 44 are arranged. Functions of the units described above may be configured by hardware such as an electronic circuit or by software such as a program executing these functions. Alternatively, they may be configured by a combination of hardware and software. Information input/output from/to the units described above and information being calculated are stored in a memory (not shown) each time.

As described above, FIG. 1 shows a structure necessary for explaining Embodiment 1. Other structure elements generally necessary for the writing apparatus 100 may also be included. For example, although a multiple stage deflector namely the two stage deflector of the main deflector 208 and the sub deflector 209 is herein used for position deflection, a single stage deflector or a multiple stage deflector of three or more stages may also be used for position deflection.

Chip data of a chip including a plurality of cells each configured by at least one figure pattern is input from the outside the apparatus to be stored in the storage device 140 (storage unit). Figure pattern data indicating the shape, alignment coordinates, and the size of each figure pattern is defined in the chip data. In other words, each figure pattern data indicating the shape, alignment coordinates, and the size of each figure pattern in a chip, which includes a plurality of figure patterns, is defined in the chip data.

For writing a figure pattern by the writing apparatus 100, it is necessary to divide each figure pattern defined in the chip data such that a divided figure pattern has a size to be beam-irradiated by one beam shot. First, the number of shots for writing the chip is estimated by calculation by the control computer 110. Then, the writing time for writing the chip is predicted by using the calculated number of shots. On the other hand, a pattern density ρ of each of the regions of a plurality of sizes is respectively calculated by the control computer 110. It is preferable to use the pattern density ρ for correcting a dose in writing.

In a figure pattern data read-out step, the figure pattern read-out unit 10 reads each figure pattern data in each cell in the chip data. Each read figure pattern data is output to the shot division processing unit 12.

In a shot division image information generation step, the shot division processing unit 12 assumes each shot figure obtained by dividing each figure pattern into shot figures. Specifically, the shot division processing unit 12 inputs each figure pattern data in the chip data, and, divides each figure pattern into a plurality of shot figures each having a size which can be irradiated with one shot of an electron beam 200. Then, the shot division processing unit 12 generates shot division image information by which the size and the arrangement position of each shot figure in the figure pattern after the dividing can be discriminated. The shot division processing unit 12 is an example of a shot division image information generation unit.

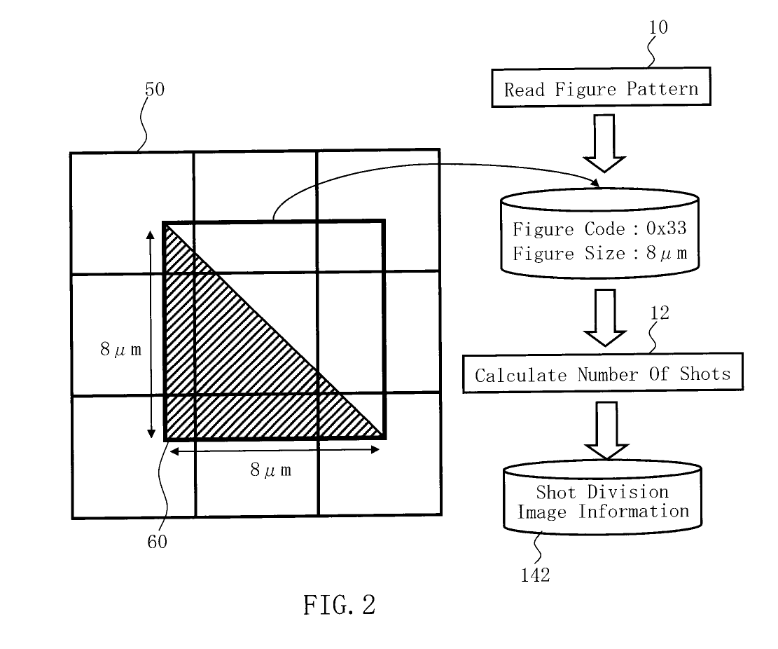

FIG. 2 is a schematic diagram showing an example of a figure pattern and a divided cell region in a cell according to Embodiment 1. In the case of FIG. 2, a figure pattern 60 having a size of 8 μm×8 μm in the x and y directions is arranged in a certain cell. The region of the cell is virtually divided into a plurality of mesh-like divided cell regions 50 obtained by dividing the cell region by 5 μm in the x and y directions from the end portion of the cell. Thus, the divided cell region 50 (an example of a mesh region) is obtained by virtually dividing into a plurality of mesh regions segmented by a predetermined size from the reference position, which is different from the end portion of the figure pattern, in the chip region indicated by chip data.

As described above, if a part of the figure pattern 60 is allotted, intact, to the divided cell region 50, and figure data of the figure in each divided cell region 50 is output to the shot division processing unit 12, there may be a case where the size of the allotted figure is incorrect. This occurs because the divided cell region 50 is generated regardless of the end portion of the figure pattern 60. Moreover, there may be a case where when the shape of the allotted figure is divided into shot figures such as a pentagon, there is a possibility of easily generating a minute figure. This arises because the divided cell region 50 is generated based on a mesh size unrelated to the size of dividing the figure pattern 60 into shot figures. Then, according to Embodiment 1, it is configured not to output figure data in each divided cell region 50 to the shot division processing unit 12 but to output figure data based on each figure pattern to the shot division processing unit 12. In the example of FIG. 2, the figure pattern read-out unit 10 outputs, for example, a figure code (0×33) and a figure size 8 μm as the figure data of the figure pattern 60.

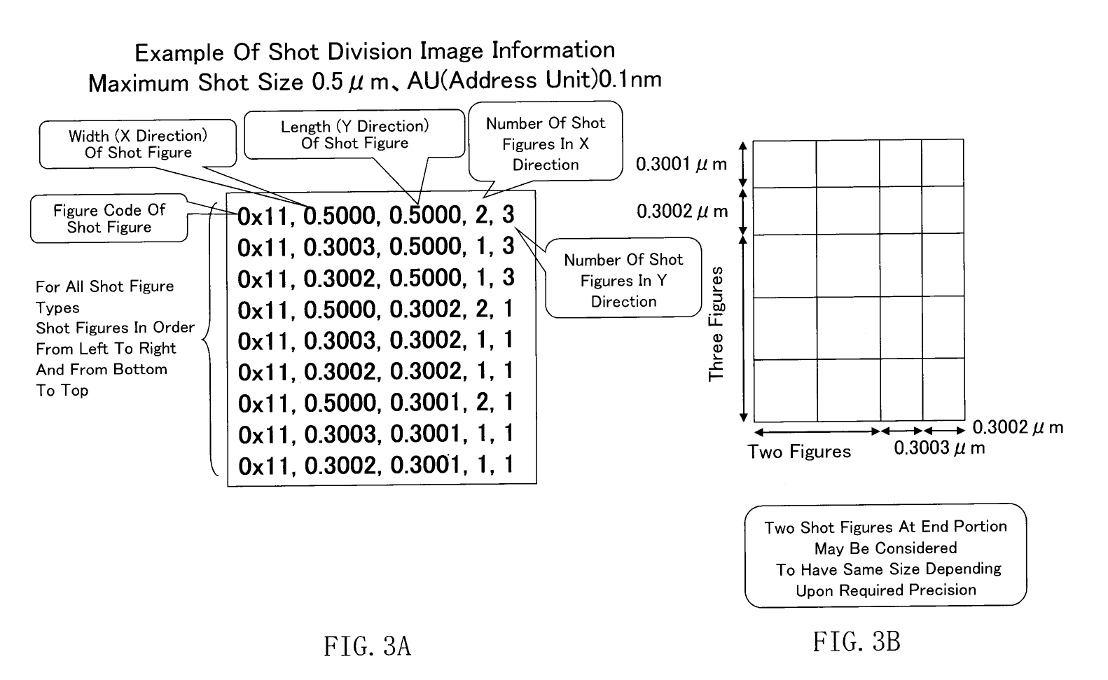

FIGS. 3A and 3B are schematic diagrams showing an example of the shot division image information according to Embodiment 1. In FIGS. 3A and 3B, to facilitate understanding the contents, there is shown, as an example, a case of dividing a rectangular (quadrangular) figure pattern into shot figures. When dividing into shot figures, the dividing is performed based on the following rules, for example.

First, as shown in FIG. 3B, the figure pattern is divided by the maximum shot size in the x and y directions respectively starting from the reference position, for example, the lower left vertex. Then, when a remaining width in the x direction becomes shorter than the maximum shot size, the remaining width and the maximum shot width which is located just before the remaining width are added and then divided by two in order to perform averaging. After the averaging, the two averaged widths may be the same according to required precision, and if they are not divisible within predetermined digits, it is acceptable that an error arises at a predetermined digit position after the decimal point, for example. This can be similarly applied to the shot dividing described below. With respect to the y direction, when a remaining length in the y direction becomes shorter than the maximum shot size, the remaining length and the maximum shot length which is located just before the remaining length are added and then divided by two in order to perform averaging. Also in this case, after the averaging, the two averaged lengths may be the same according to required precision, and if they are not divisible within predetermined digits, it is acceptable that an error arises at a predetermined digit position after the decimal point, for example. This can be similarly applied to the shot dividing described below.

Therefore, in the example of FIG. 3B, first, the figure pattern is divided into six squares of the maximum shot size, in two columns in the x direction and in three rows in the y direction from the lower left position. In this case, for example, 0.5 μm is used as the maximum shot size. With respect to the x direction, the added remaining width is divided into two averaged widths. In the example of FIG. 3B, the remaining width in the x direction is divided to be 0.3003 μm wide and 0.3002 μm wide. If it is not divisible within predetermined digits after the decimal point, an error will somewhat arise at the last digit. Next, with respect to the y direction, the added remaining length is divided into two averaged lengths. In the example of FIG. 3B, the remaining length in the y direction is divided to be 0.3002 μm long and 0.3001 μm long. If it is not divisible within predetermined digits after the decimal point, an error will somewhat arise at the last digit. Therefore, with respect to the figures in the third and fourth columns from the left in the x direction, the length of each of the figures in the first to third rows from the bottom in the y direction is the maximum shot size in the y direction, and the length of each of the figures in the fourth and fifth rows in the y direction is the averaged length obtained by dividing the remaining length by two to average in the y direction. Similarly, with respect to the figures in the fourth and fifth rows in the y direction, the width of each of the figures in the first and second columns in the x direction is the maximum shot size in the x direction, and the width of each of the figures in the third and fourth columns in the x direction is the averaged width obtained by dividing the remaining width by two to average in the x direction.

Shot division image information is generated with respect to shot figures made by dividing a figure into shots as described above. FIG. 3A shows an example of the shot division image information. The shot division image information according to Embodiment 1 is generated based on the following rules. The shot division image information is defined in the x direction (the first direction) from the reference position (lower left vertex position) of a figure pattern concerned, in order of a figure code indicating the shape of a shot figure, the size, and the number of identical shot figures continuously arranged. When reaching the end portion of the figure pattern concerned with respect to the x direction, shifting is performed each time in the y direction (the second direction) perpendicular to the x direction, and then, again, a figure code indicating the shape of the shot figure, the size, and the number of identical shot figures continuously arranged are defined in the x direction. The defining is repeatedly performed in order until all the shot figures made by dividing a figure pattern concerned are covered.

In the example of FIG. 3A, first, “0x11” which indicates a quadrangle is defined as a figure code of the shot figure, and then, the size in the x direction is to be defined.

In this case, since the width is the maximum shot size, “0.5000” is defined. Next, the size in the y direction is to be defined. In this case, since the length is also the maximum shot size, “0.5000” is defined. Next, the number of identical shot figures continuously arranged in the x direction is to be defined. In this case, since there are two, “2” is defined. Next, the number of identical shot figures continuously arranged in the y direction is to be defined. In this case, since there are three, “3” is defined.

Next, in the remaining two columns in the x direction, with respect to the shot figure in the last column but one which is closer to the reference position, “0x11” indicating a quadrangle is defined as a figure code, and then, the size in the x direction is to be defined. In this case, since the width is 0.3003 μm, “0.3003” is defined. Next, the size in the y direction is to be defined. In this case, since the length is the maximum shot size, “0.5000” is defined. Next, the number of identical shot figures continuously arranged in the x direction is to be defined. In this case, since there is one, “1” is defined. Next, the number of identical shot figures continuously arranged in the y direction is to be defined. In this case, since there are three, “3” is defined.

Next, in the remaining two columns in the x direction, with respect to the shot figure in the last column which is farther from the reference position, “0x11” indicating a quadrangle is defined as a figure code, and then, the size in the x direction is to be defined. In this case, since the width is 0.3002 μm, “0.3002” is defined. Next, the size in the y direction is to be defined. In this case, since the length is the maximum shot size, “0.5000” is defined. Next, the number of identical shot figures continuously arranged in the x direction is to be defined. In this case, since there is one, “1” is defined. Next, the number of identical shot figures continuously arranged in the y direction is to be defined. In this case, since there are three, “3” is defined.

Next, concerning the last row but one, closer to the reference position, in the remaining two rows in the y direction, with respect to the shot figure in the first column in the x direction, “0x11” indicating a quadrangle is defined as a figure code, and then, the size in the x direction is to be defined. In this case, since the width is the maximum shot size, “0.5000” is defined. Next, the size in the y direction is to be defined. In this case, since the length is 0.3002 μm, “0.3002” is defined. Next, the number of identical shot figures continuously arranged in the x direction is to be defined. In this case, since there are two, “2” is defined. Next, the number of identical shot figures continuously arranged in the y direction is to be defined. In this case, since there is one, “1” is defined.

Next, concerning the last row but one, closer to the reference position, in the remaining two rows in the y direction, with respect to the shot figure in the last column but one, closer to the reference position, in the remaining two columns in the x direction, “0x11” indicating a quadrangle is defined as a figure code, and then, the size in the x direction is to be defined. In this case, since the width is 0.3003 μm, “0.3003” is defined. Next, the size in the y direction is to be defined. In this case, since the length is 0.3002 μm, “0.3002” is defined. Next, the number of identical shot figures continuously arranged in the x direction is to be defined. In this case, since there is one, “1” is defined. Next, the number of identical shot figures continuously arranged in the y direction is to be defined. In this case, since there is one, “1” is defined.

Next, concerning the last row but one, closer to the reference position, in the remaining two rows in the y direction, with respect to the shot figure in the last column, farther from the reference position, in the remaining two columns in the x direction, “0x11” indicating a quadrangle is defined as a figure code, and then, the size in the x direction is to be defined. In this case, since the width is 0.3002 μm, “0.3002” is defined. Next, the size in the y direction is to be defined. In this case, since the length is 0.3002 μm, “0.3002” is defined. Next, the number of identical shot figures continuously arranged in the x direction is to be defined. In this case, since there is one, “1” is defined. Next, the number of identical shot figures continuously arranged in the y direction is to be defined. In this case, since there is one, “1” is defined.

Next, concerning the last row, farther from the reference position, in the remaining two rows in the y direction, with respect to the shot figure in the first column in the x direction, “0x11” indicating a quadrangle is defined as a figure code, and then, the size in the x direction is to be defined. In this case, since the width is the maximum shot size, “0.5000” is defined. Next, the size in the y direction is to be defined. In this case, since the length is 0.3001 μm, “0.3001” is defined. Next, the number of identical shot figures continuously arranged in the x direction is to be defined. In this case, since there are two, “2” is defined. Next, the number of identical shot figures continuously arranged in the y direction is to be defined. In this case, since there is one, “1” is defined.

Next, concerning the last row, farther from the reference position, in the remaining two rows in the y direction, with respect to the shot figure in the last column but one, closer to the reference position, in the remaining two columns in the x direction, “0x11” indicating a quadrangle is defined as a figure code, and then, the size in the x direction is to be defined. In this case, since the width is 0.3003 μm, “0.3003” is defined. Next, the size in the y direction is to be defined. In this case, since the length is 0.3001 μm, “0.3001” is defined. Next, the number of identical shot figures continuously arranged in the x direction is to be defined. In this case, since there is one, “1” is defined. Next, the number of identical shot figures continuously arranged in the y direction is to be defined. In this case, since there is one, “1” is defined.

Next, concerning the last row, farther from the reference position, in the remaining two rows in the y direction, with respect to the shot figure in the last column, farther from the reference position, in the remaining two columns in the x direction, “0x11” indicating a quadrangle is defined as a figure code, and then, the size in the x direction is to be defined. In this case, since the width is 0.3002 μm, “0.3002” is defined. Next, the size in the y direction is to be defined. In this case, since the length is 0.3001 μm, “0.3001” is defined. Next, the number of identical shot figures continuously arranged in the x direction is to be defined. In this case, since there is one, “1” is defined. Next, the number of identical shot figures continuously arranged in the y direction is to be defined. In this case, since there is one, “1” is defined.

As described above, the defining is repeatedly performed until all the shot figures made by dividing the figure pattern concerned are covered in order in the shot division image information. By defining in order according to a certain fixed rule, it becomes possible in the shot division image information to discriminate, after dividing the figure pattern into shot figures, the size and the arrangement position of each shot figure in the figure pattern. The generated shot division image information is stored in the storage device 142 and output to the allotting processing unit 14. Alternatively, the allotting processing unit 14 may read the generated shot division image information from the storage device 142.

According to Embodiment 1, since each figure pattern is divided into shot figures, when an identical figure pattern is repeatedly arranged, it is enough to generate shot division image information for one of them, for example, for the first one of the identical figure patterns, and then, to share the generated shot division image information with other identical figure patterns. As a result, the processing contents of the shot division processing unit 12 can be reduced, and the processing time can be further shortened. Particularly, it is effective for array patterns.

Next, in an allotting processing step, by using shot division image information and alignment coordinates information of each figure pattern, the allotting processing unit 14 allots each of shot figures, which are obtained by dividing the figure pattern, to each divided cell region so that each shot figure may be arranged in the divided cell region concerned. The alignment coordinates of the figure pattern can be referred to from the pattern data of the figure pattern concerned.

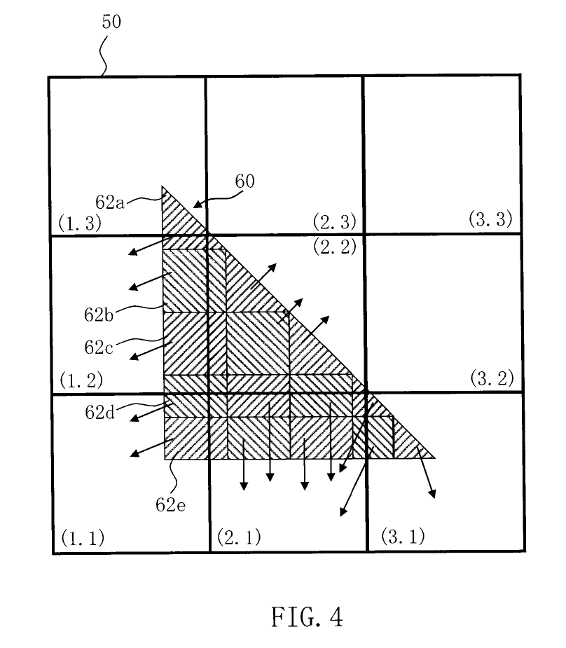

FIG. 4 is a schematic diagram explaining allotting processing with respect to a divided cell region according to Embodiment 1. FIG. 4 shows the case, as an example, of allotting each shot figure obtained by dividing the figure pattern of a right angled triangle shown in FIG. 2 into shot figures. In FIG. 4, the cell region is divided into nine (3×3) divided cell regions 50 in the x and the y directions, for example. The allotting processing unit 14 allots each divided shot FIG. 62 to the divided cell region 50 such that the reference position, for example, the lower left vertex position, of the divided shot FIG. 62 overlaps with the divided cell region 50. In the example of FIG. 4, shot FIGS. 62d and 62e are allotted to the divided cell region 50 of the coordinates (1, 1). Shot FIGS. 62a, 62b, and 62c are allotted to the divided cell region 50 of the coordinates (1, 2). Similarly, other shot FIGS. 62 are allotted to the divided cell region 50 of the other coordinates.

According to Embodiment 1 as described above, by outputting data of a figure pattern itself, without dividing a figure pattern into mesh regions, to the shot division processing unit 12, it becomes possible to avoid the conventional case that the shape of a figure in a mesh, which is to be output to a function equivalent to the shot division processing unit 12, becomes a figure, such as a pentagon, being easy to generate a minute figure. Moreover, it becomes possible to avoid the conventional case that the size of a figure in a mesh is defined based on a division size of a mesh region. Therefore, when dividing a figure pattern into shot figures by the processing unit 12, it can be avoided to perform the dividing based on an erroneous figure size.

In a cell division shot number calculation step, the cell division shot number calculation unit 16 calculates, for each divided cell region 50 (mesh region), the number of shots of the electron beam 200 used when writing the inside of the divided cell region 50 concerned, based on the number of allotted shot figures.

In a cell division pattern density calculation step, the cell division pattern density calculation unit 30 totalizes, for each divided cell region 50 (mesh region), areas of allotted shot figures to calculate a pattern density ρ (area density) of the divided cell region 50 concerned. With respect to a shot figure which extends from a divided cell region concerned, it is preferable to separate the area of the extending, and add the separated area to another divided cell region which is being extended. The calculated pattern density ρ is stored in the storage device 144.

In a chip division shot number calculation step, the chip division shot number calculation unit 18 totalizes, for each divided chip region (mesh region), the number of shots of the divided cell regions 50 allotted to a divided chip region concerned, in order to calculate the number of shots of the electron beam 200 used when writing the inside of the divided chip region concerned. As explained with reference to FIGS. 11A and 11B, etc., with respect to a divided chip region, in the case of the object being one chip, the region of the chip is virtually divided into mesh-like divided chip regions each being larger than the size of the divided cell region 50, and in the case of the object being composed of merged plural chips, the virtual chip region, namely the circumscribing quadrangular region of the merged chips is virtually divided into mesh-like divided chip regions each being larger than the size of the divided cell region 50. Moreover, the divided cell region 50 may be allotted to a divided chip region with which the reference position, for example, the lower left vertex position of the divided cell region 50 overlaps.

In a chip division pattern density calculation step, the chip division pattern density calculation unit 32 totalizes, for each divided chip region (mesh region), pattern densities p of the divided cell regions 50 allotted to a divided chip region concerned in order to calculate the pattern density ρ of the divided chip region concerned. The calculated pattern density ρ is stored in the storage device 144.

Here, the chip region is virtually divided into a plurality of strip-like frame regions, for example, in the y direction, each having a predetermined width. In the writing apparatus 100, data processing is performed for each frame region or for each processing region made by dividing the frame region into a plurality of blocks. Therefore, it is desirable to totalize the number of shots and pattern densities in each frame.

In a frame shot number calculation step, the frame shot number calculation unit 20 totalizes, for each frame region, the number of shots of the divided chip regions? allotted to a frame region in order to calculate the number of shots of the electron beam 200 used when writing the inside of the frame region concerned. Moreover, the divided chip region may be allotted to a frame region with which the reference position, for example, the lower left vertex position of the divided chip region overlaps.

In a frame pattern density calculation step, the frame pattern density calculation unit 34 totalizes, for each frame region, pattern densities p of divided chip regions allotted to a frame region concerned in order to calculate the pattern density ρ in the frame region concerned. The calculated pattern density ρ is stored in the storage device 144.

In a chip shot number calculation step, the chip shot number calculation unit 22 totalizes, for each chip region, the number of shots of frame regions allotted to a chip region concerned in order to calculate the number of shots of the electron beam 200 used when writing the inside of the chip region concerned.

In a chip pattern density calculation step, the chip pattern density calculation unit 36 totalizes, for each chip region, pattern densities p of the frame regions allotted to a chip region concerned in order to calculate a pattern density ρ of the chip region concerned. The calculated pattern density ρ is stored in the storage device 144.

Although the case of writing one chip is assumed here, if there are a plurality of chips whose writing conditions are the same, it is also preferable to perform merge processing for them to configure one chip. In that case, the number of shots and the pattern density ρ are to be calculated for each chip after being merged.

As described above, the total number of shots used when writing the chip concerned can be obtained. By providing hierarchy in the region, calculating the number of shots and a pattern density ρ in order starting from a region of a smaller hierarchy, and accumulating the results, it becomes possible to highly accurately estimate the number of shots and the pattern density ρ. Moreover, since no divided pattern region is set according to Embodiment 1, though the setting has been performed conventionally, it is possible to eliminate calculation of the number of shots and the pattern density ρ of each divided pattern region, thereby greatly reducing the processing time as a whole. Moreover, although the processing contents of the processing unit 12 of dividing a figure which has been output to the processing unit 12 into shot size figures is unchanged, since the processing of dividing into shot figures is not performed for each divided pattern region, but performed for each figure pattern, the number of times of processing can also be reduced.

Using a shot number Nₜₒₜₐₗ of each chip acquired as described above, a writing time for writing the chip concerned is predicted.

In a writing time prediction step, the writing time prediction unit 24 predicts a writing time for writing a chip concerned, based on the number of shots of each mesh region, such as a divided cell region and a divided chip region. The writing time prediction unit 24 calculates a total writing time Tes for writing a chip on the target workpiece 101, using the following equation (1), for example.

Tes=α₁·Nₜₒₜₐₗ+β₁ (1)

The coefficient α₁ indicates a time (shot cycle) necessary per shot. For example, it can be represented as the sum of a time t₁ for obtaining a required dose D and a time t₂ (settling time) for deflecting the electron beam 200. Expressing the current density as J, it can be represented as t₁=D/J, for example. The coefficient β₁ indicates a total time necessary when the XY stage 105 moves to the writing starting position of the next stripe region after one stripe region has been written. What is necessary is just to set these coefficients α₁ and β₁ as parameters in advance.

When writing with an electron beam, a chip region is divided into a plurality of strip-like stripe regions, for example, in the y direction, each having a predetermined width. Writing processing is executed per stripe region. When writing on the target workpiece 101 while the XY stage 105 is continuously moved, for example, in the x direction, the electron beam 200 irradiates one stripe region of the target workpiece 101, which is made by virtually dividing the writing (exposure) surface into a plurality of strip-like stripe regions where the electron beam 200 is deflectable. The movement of the XY stage 105 in the x direction is a continuous movement, and simultaneously, the shot position of the electron beam 200 is made to follow the movement of the stage. Writing time can be shortened by performing the continuous movement. After writing one stripe region, the XY stage 105 is moved in the y direction by step feeding, and then, returned in the x direction (this time, reverse direction) to the writing starting position of the next stripe region. From that position, the writing operation of the next stripe region is started. Thus, the writing operation is performed by forward(Fwd)-forward(Fwd) movement. It is possible to avoid positional deviation, generated between going and returning of the stage system, by proceeding in the forward(Fwd)-forward (Fwd) movement. However, it is also acceptable to perform forward (Fwd)-back forward (Bwd) movement, that is, after finishing writing one stripe region, the XY stage 105 is moved in the y direction by step feeding, and then, the writing operation of the next stripe region is performed in the x direction (this time, reverse direction). In this case, by performing the writing operation in a zigzag manner for each stripe region, the movement time of the XY stage 105 can be shortened.

It is possible to predict a writing time highly precisely by predicting the writing time based on highly accurate number of shots as described above. The predicted writing time is output to, for example, a monitor, a printer, a storage device, which are not shown, or the outside to be recognized by a user.

After predicting the writing time, writing processing is actually proceeded for the chip.

In a shot data generating step, the shot data generation unit 40 reads out chip data from the storage device 140, performs data conversion processing of several steps, and generates shot data unique to the apparatus. As described above, for writing a figure pattern by the writing apparatus 100, it is necessary to divide each figure pattern defined in the writing data so as to have the size which can be irradiated by one beam shot. Therefore, for actual writing, the shot data generation unit 40 divides each figure pattern so as to have the size which can be irradiated by one beam shot, in order to generate a shot figure. Then, shot data is generated for each shot figure. In the shot data, figure data, such as a figure type, a figure size, and an irradiation position, is defined. The generated shot data is stored in the storage device 146.

In a dose calculation step, the dose calculation unit 42 calculates a dose for each mesh region of a predetermined size. The dose can be calculated by multiplying a base dose Dbase by a correction coefficient. It is preferable to use as a correction coefficient, for example, a fogging-effect correction irradiation coefficient Df(ρ) which is for correcting a fogging effect. The fogging-effect correction irradiation coefficient Df(ρ) is a function depending on a pattern density ρ of a mesh of meshes used in calculation for correcting the fogging-effect. Since the influence radius of the fogging-effect is several mm, it is preferable for the size of the mesh for correcting the fogging-effect to be approximately 1/10 of the influence radius, for example, to be 1 mm, in order to perform correction calculation. As the pattern density ρ of the mesh for fogging, the pattern density calculated in each hierarchy mentioned above can be used. In addition, for correcting a dose, it is also preferable to use a correction coefficient for proximity effect correction, a correction coefficient for loading correction, etc. Also in such correction, the pattern density in the mesh region for each calculation can be used. As the pattern density, the pattern density calculated in each hierarchy mentioned above may also be used. The dose calculation unit 42 generates a dose map in which each calculated dose is defined for each region. As described above, according to Embodiment 1, since a highly precise pattern density ρ can also be obtained as a pattern density ρ used when performing dose correction, it is possible to calculate a highly accurately corrected dose. The generated dose map is stored in the storage device 146.

In a writing step, the writing processing unit 44 outputs a control signal in order to make the control circuit 130 perform writing processing. The control circuit 130 inputs shot data and a dose map from the storage device 146, and controls the writing unit 150 based on the control signal, through the writing processing unit 44. The writing unit 150 writes a pattern in a chip concerned on the target workpiece 100 using the electron beam 200. Specifically, the operation is performed as follows:

The electron beam 200 emitted from the electron gun 201 (emission unit) irradiates the entire first aperture plate 203 having a quadrangular opening by the illumination lens 202. At this point, the electron beam 200 is shaped to be a quadrangle. Then, after having passed through the first aperture plate 203, the electron beam 200 of a first aperture image is projected onto the second aperture plate 206 by the projection lens 204. The first aperture image on the second aperture plate 206 is deflection-controlled by the deflector 205 so as to change the shape and size of the beam to be variably shaped. After having passed through the second aperture plate 206, the electron beam 200 of a second aperture image is focused by the objective lens 207 and deflected by the main deflector 208 and the sub deflector 209, and reaches a desired position on the target workpiece 101 on the XY stage 105 which moves continuously. FIG. 1 shows the case of using a multiple stage deflection, namely the two stage deflector of the main and sub deflectors, for position deflection. In such a case, what is needed is to deflect the electron beam 200 of a shot concerned to the reference position of a subfield (SF), which is made by further dividing the stripe region virtually, by the main deflector 208 while following the stage movement, and to deflect the beam of the shot concerned to each irradiation position in the SF by the sub deflector 209.

According to Embodiment 1, even when not setting a division region further up to a divided pattern region which has been set conventionally, it is possible to suppress dividing into shot figures of an incorrect size. Moreover, it is possible to suppress generating of a minute figure. Therefore, accurate number of shots can be obtained. As a result, highly precise writing time can be predicted. Moreover, dose correction can be performed highly precisely.

### Embodiment 2

In Embodiment 2, there will be explained shot division image information of a different format. The apparatus configuration is the same as that of FIG. 1. Hereinafter, contents not particularly described are the same as those of Embodiment 1.

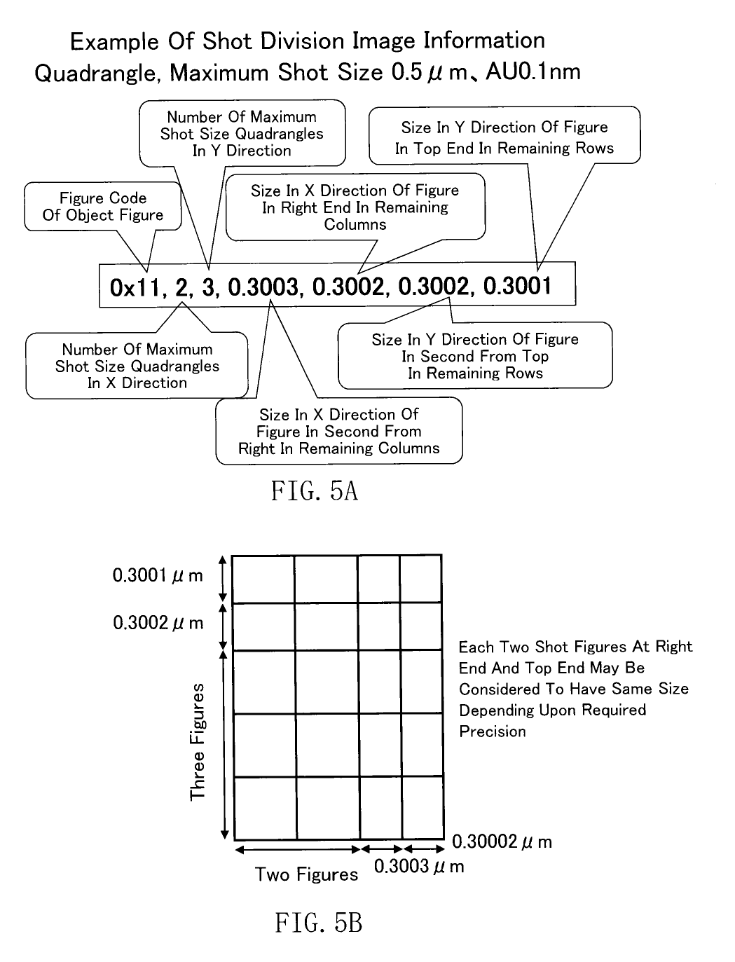

FIGS. 5A and 5B are schematic diagrams showing an example of shot division image information according to Embodiment 2. In FIG. 5A and FIG. 5B, to facilitate understanding the contents, there is shown a case of dividing a rectangular (quadrangular) figure pattern into shot figures, as an example. The size, shape, etc. of a shot figure shown in FIG. 5B are the same as those of FIG. 3B. The rule of shot division image information herein differs from that of Embodiment 1.

Shot division image information is generated with respect to shot figures made by dividing a figure into the shot figures as shown in FIG. 5B. The shot division image information according to Embodiment 2 is generated based on the following rules as shown in FIG. 5A. The shot division image information is defined in the x direction (the first direction) from the reference position (lower left vertex position) of a figure pattern concerned, in order of a figure code indicating the shape of an original figure pattern to be divided, the number of shot figures having been divided by the maximum shot size and continuously arranged, and the size of remaining figures with respect to the x direction. The defining is repeatedly performed in order until all the shot figures made by dividing a figure pattern concerned become discriminable.

In the example of FIG. 5A, first, “0x11” which indicates a quadrangle is defined as a figure code of an original figure pattern to be divided. Next, the number of shot figures having been divided by the maximum shot size and continuously arranged in the x direction is to be defined. In this case, since there are two, “2” is defined. Then, the number of shot figures having been divided by the maximum shot size and continuously arranged in the y direction is to be defined. In this case, since there are three, “3” is defined.

Next, with respect to the remaining two columns in the x direction, the size in the x direction of the shot figure in the last column but one, closer to the reference position, is to be defined. In this case, since the width is 0.3003 μm, “0.3003” is defined.

Next, with respect to the remaining two columns in the x direction, the size in the x direction of the shot figure in the last column, farther from the reference position, is to be defined. In this case, since the width is 0.3002 μm, “0.3002” is defined.

Next, with respect to the remaining two rows in the y direction, the size in the y direction of the shot figure in the last row but one, closer to the reference position, is to be defined. In this case, since the width is 0.3002 μm, “0.3002” is defined.

Next, with respect to the remaining two rows in the y direction, the size in the y direction of the shot figure in the last row, farther from the reference position, is to be defined. In this case, since the width is 0.3001 μm, “0.3001” is defined.

Using the information described above, when the maximum shot size is set in advance, it is possible to discriminate all the division sizes. That is, with respect to the x direction, after twice dividing by the maximum shot size, when dividing the remaining width in the x direction by 0.3003 μm, a figure whose width is 0.3003 μm and a figure whose width is 0.3002 μm are formed. With respect to the y direction, after three times dividing by the maximum shot size, when dividing the remaining length in the y direction by 0.3002 μm, a figure whose length is 0.3002 μm and a figure whose length is 0.3001 μm are formed.

When divided into a grid of the division size described above, as shown in FIG. 5B, there are formed: six shot figures of the maximum shot size in two (first and second) columns in the x direction and in three (first to third) rows in the y direction from the reference position, three shot figures in the third column and in three (first to third) rows each having the width of 0.3003 μm in the x direction and the length of the maximum shot size in the y direction, three shot figures in the fourth column and in three (first to third) rows each having the width of 0.3002 μm in the x direction and the length of the maximum shot size in the y direction, two shot figures in two (first and second) columns and in the fourth row each having the width of the maximum shot size in the x direction and the length of 0.3002 μm in the y direction, one shot figure in the third column and in the fourth row having the width of 0.3003 μm in the x direction and the length of 0.3002 μm in the y direction, one shot figure in the fourth column and in the fourth row having the width of 0.3002 μm in the x direction and the length of 0.3002 μm in the y direction, two shot figures in two (first and second) columns and in the fifth row each having the width of the maximum shot size in the x direction and the length of 0.3001 μm in the y direction, one shot figure in the third column and in the fifth row having the width of 0.3003 μm in the x direction and the length of 0.3001 μm in the y direction, and one shot figure in the fourth column and in the fifth row having the width of 0.3002 μm in the x direction and the length of 0.3001 μm in the y direction.

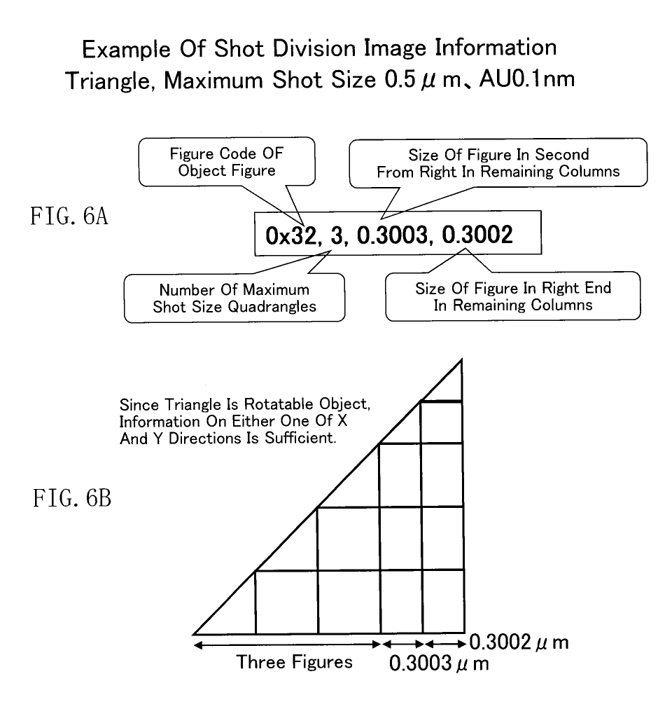

FIGS. 6A and 6B are schematic diagrams showing another example of shot division image information according to Embodiment 2. In FIGS. 6A and 6B, there is shown, as an example, a case of dividing an isosceles right triangle pattern into shot figures. When dividing into shot figures, the dividing is performed based on the following rules, for example.

First, as shown in FIG. 6B, the figure pattern is divided by the maximum shot size in the x and y directions respectively starting from the reference position, for example, the lower left vertex. Then, when a remaining width in the x direction becomes shorter than the maximum shot size, the remaining width and the maximum shot width which is located just before the remaining width are added and then divided by two in order to perform averaging. Similarly, with respect to the y direction, when a remaining length in the y direction becomes shorter than the maximum shot size, the remaining length and the maximum shot length which is located just before the remaining length are added and then divided by two in order to perform averaging.

Therefore, in the example of FIG. 6B, first, the figure pattern is divided into six figures of the maximum shot size in three columns in the x direction and in three rows in the y direction from the lower left position. However, in the example of FIG. 6B, since a right-angled vertex is located at a lower right position and a 45 degree vertex is located at the reference position, after the dividing, three isosceles right triangles are formed respectively in the first column in the x direction and the first row in the y direction, in the second column and the second row, and in the third column and the third row. After the dividing, three squares are formed respectively in the second column and the first row, and in the third column and the first and second rows. In this case, for example, 0.5 μm is used as the maximum shot size. With respect to the x direction, the added remaining width is divided into two averaged widths. In the example of FIG. 6B, the remaining width in the x direction is divided to be 0.3003 μm wide and 0.3002 μm wide. With respect to the y direction, the added remaining length is divided into two averaged lengths. In the example of FIG. 6B, the remaining length in the y direction is divided to be 0.3003 μm long and 0.3002 μm long. If it is not divisible within predetermined digits after the decimal point, an error will somewhat arise at the last digit.

Shot division image information is generated with respect to shot figures made by dividing a figure pattern into shots as described above. The shot division image information which is based on the isosceles right triangle as the original figure pattern is generated according to the following rules as shown in FIG. 6A. The shot division image information is defined in the x direction (the first direction) from the reference position (lower left vertex position) of a figure pattern concerned, in order of a figure code which indicates the shape of the original figure pattern to be divided, the number of shot figures having been divided by the maximum shot size and continuously arranged, and the size of a remaining figure with respect to the x direction. Since an isosceles right triangle is divided to be the same size in both the directions x and y, it is sufficient to define information on either one of the x and y directions.

In the example of FIG. 6A, first “0x32” indicating an isosceles right triangle is defined as a figure code of the original figure pattern to be divided, and then, the number of shot figures, for example, in the x direction, having been divided by the maximum shot size and continuously arranged is to be defined. In this case, since there are three, “3” is defined.

Next, for example, with respect to the remaining two columns in the x direction, the width in the x direction of the shot figure in the last column but one, closer to the reference position, is to be defined. In this case, since the width is 0.3003 μm, “0.3003” is defined.

Next, for example, with respect to the remaining two columns in the x direction, the width in the x direction of the shot figure in the last column, farther from the reference position, is to be defined. In this case, since the width is 0.3002 μm, “0.3002” is defined.

Using the information described above, when the maximum shot size is set in advance, it is possible to discriminate all the division sizes.

According to Embodiment 2 as described above, in addition to the effects according to Embodiment 1, the data amount of the shot division image information can be further reduced compared with that of Embodiment 1.

### Embodiment 3

It is possible to share shot division image information among figures having the same figure code and figure size. When adopting this method, processing time can be further shortened. In that case, in order to share shot division image information on more figures, it is desirable to have less amount of data of shot division image information on each figure. Therefore, in Embodiment 3, there will be explained shot division image information of a further different format. The apparatus configuration is the same as that of FIG. 1. Hereinafter, contents not particularly described are the same as those of Embodiment 1.

Specifically, the amount of data of shot division image information on a figure, such as a trapezoid and a parallelogram, tends to be large. Therefore, it is desirable to reduce the data amount of shot division image information with respect to, especially, such figures. Now, there will be explained an example of shot division image information whose data amount can be reduced.

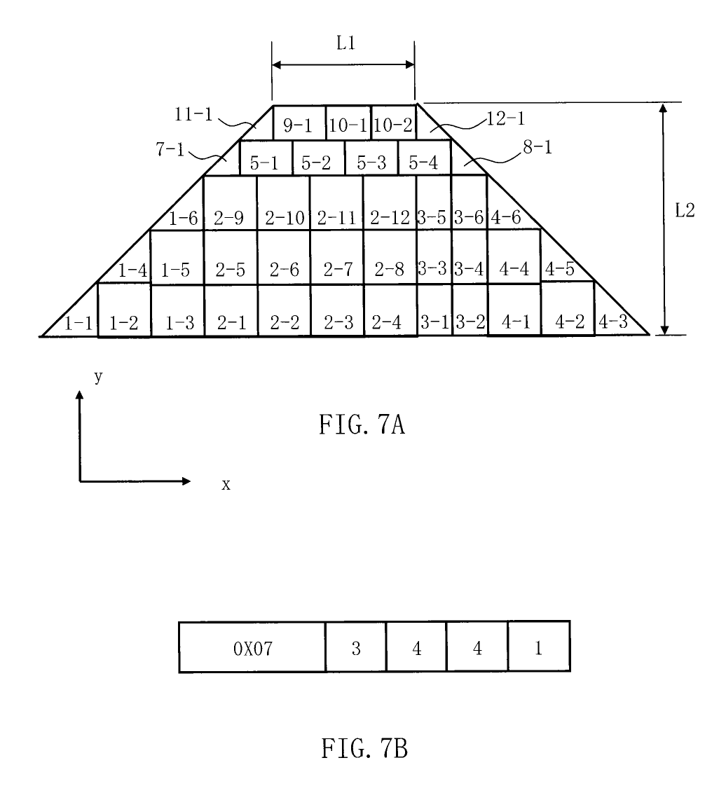

FIGS. 7A and 7B are schematic diagrams showing an example of a figure to be divided into shot figures and shot division image information thereon according to Embodiment 3. FIG. 7A shows, as an example, a trapezoid whose data amount tends to be large such as an isosceles trapezoid composed of a base (lower base) and two oblique sides each having a 45 degree angle and a 135 degree angle at both ends. The trapezoid whose lower and upper bases are in the x direction and height is in the y direction is shown as an example. FIG. 7B shows an example of shot division image information on this trapezoid. The rule of shot division image information herein differs from those of Embodiments 1 and 2.

As shown in FIG. 7B, shot division image information is generated with respect to shot figures made by dividing a figure. The shot division image information according to Embodiment 3 is generated based on the following rule, as shown in FIG. 7A. The shot division image information is defined in the x direction (the first direction) from the reference position (lower left vertex position) of a figure pattern concerned, in order of a figure code indicating the shape of the original figure pattern to be divided, and then, with respect to the region 1 where an isosceles triangle shown in FIG. 7A can be configured, the number of shot figures in the x direction having been divided by the maximum shot size in the x and y directions and continuously arranged, with respect to the region 2 where a quadrangle (rectangle or square) shown in FIG. 7A can be configured, the number of shot figures in the x direction having been divided by the maximum shot size in the x and y directions and continuously arranged, with respect to the region 5 which is the (lower) region obtained by halving the remaining length in the height direction (y direction) of the trapezoid shown in FIG. 7A, the number of shot figures in the x direction having been divided by the maximum shot size in the x direction and continuously arranged, and with respect to the region 9 which is the other (upper) region obtained by halving the remaining length in the height direction (y direction) of the trapezoid shown in FIG. 7A, the number of shot figures in the x direction having been divided by the maximum shot size in the x direction and continuously arranged.

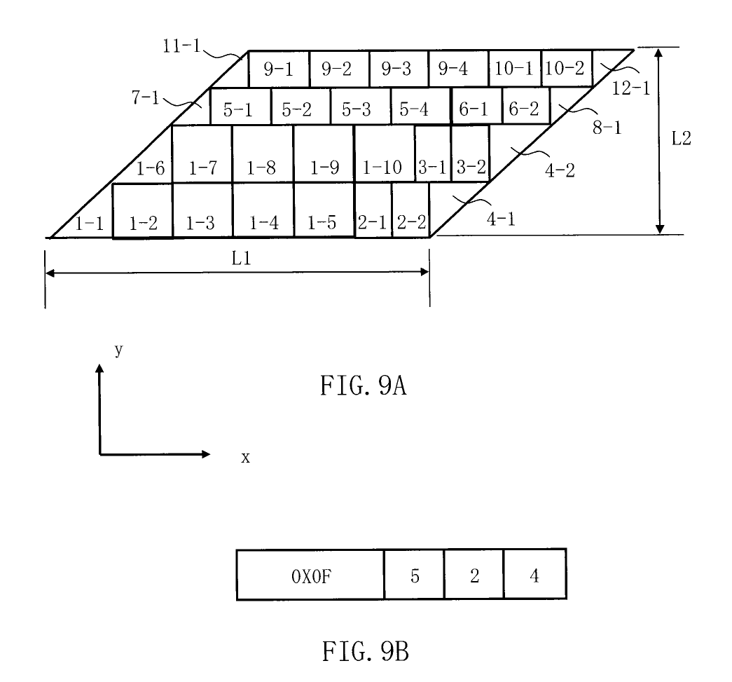

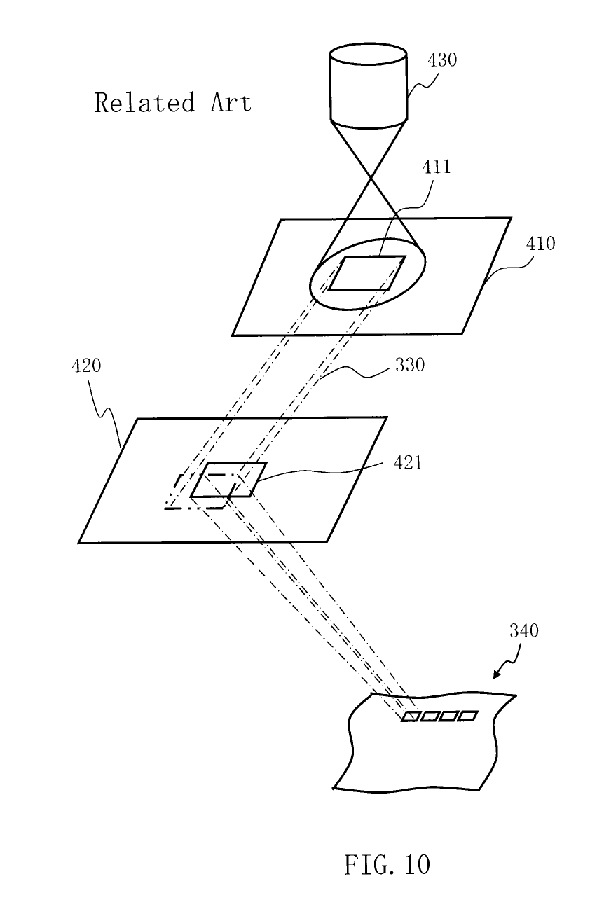

If the x and y directions are reversed with respect to the arrangement direction of the trapezoid, what is necessary is just to read the x and y directions conversely for the shot division image information described above. Therefore, the shot division image information on the isosceles trapezoid of FIG. 7A is defined as follows as shown in FIG. 7B: “0x07” indicating an isosceles trapezoid is defined as the figure code of the original figure pattern. Next, “3” is defined as the number of shot figures in the x direction out of the shot FIGS. 1-1 to 1-6) having been divided by the maximum shot size in the x and y directions and continuously arranged in the region 1. Next, “4” is defined as the number of shot figures in the x direction out of shot FIGS. 2-1 to 2-12) having been divided by the maximum shot size in the x and y directions and continuously arranged in the region 2. Next, “4” is defined as the number of shot figures in the x direction out of shot FIGS. (5-1 to 5-4) having been divided by the maximum shot size in the x direction and continuously arranged in the region 5. Lastly, “1” is defined as the number of shot figures in the x direction out of shot FIGS. 9-1) having been divided by the maximum shot size in the x direction and continuously arranged in the region 9.

As described above, when a figure pattern is a trapezoid composed of a base, and two oblique sides each having a 45 degree angle and a 135 degree angle at both ends, the shot division image information can be defined by specifying therein the figure code indicating a trapezoid and the number of shot figures having been divided, according to the pre-set order, by the maximum shot size with respect to one of the directions x and y. Now, the steps of discriminating each shot figure based on the shot division image information will be explained. First, as to the isosceles trapezoid described above, the figure code “0x07”, the upper base (L1), and the height (L2) have already been defined in the original pattern data.

The following can be understood from the shot division image information. Based on the figure code “0x07”, it can be understood that the figure concerned is an isosceles trapezoid. Next, based on “3”, the figure pattern can be divided in the x direction (the first direction) from the reference position (lower left vertex position) of the figure pattern concerned into three figures at the bottom part by the maximum shot size. Since the oblique side is inclined by 45 degrees in the isosceles trapezoid, the figure can also be similarly divided into three shot figures in the y direction by the maximum shot size. Therefore, the region 1 can be divided into three isosceles triangles (1-1, 1-4, 1-6) along the oblique side, two squares (1-2, 1-3) in the x direction next to the isosceles triangle (1-1), and one square (1-5) in the x direction next to the isosceles triangle (1-4).

Next, based on “4”, the region 2 can be divided into four shot figures in the x direction by the maximum shot size. As described above, since the region 1 can be divided into three shot figures in the y direction by the maximum shot size, it is also understood that the region 2 can be divided into three figures in the y direction by the maximum shot size. Therefore, the region 2 can be divided into twelve (4×3) squares (2-1 to 2-12).

Moreover, since there is configured the region 4 symmetrical to the region 1 with respect to the y-axis in the isosceles trapezoid, the region 4 can also be divided into three figures in the x and y directions by the maximum shot size. Therefore, the region 4 can be divided into three isosceles triangles (4-3, 4-5, 4-6) and three squares (4-1, 4-2, 4-4).

Next, since the length L1 of the upper base and the height L2 have already been known, the length of the lower base can be obtained. Therefore, one half of the width in the x direction of the region 3 can be obtained by excluding the regions 1, 2, and 4 and halving the remaining width in the x direction. Moreover, as described above, since the region 1 can be divided into three shot figures in the y direction by the maximum shot size, the region 3 can also be divided into three figures in the y direction by the maximum shot size. Therefore, the region 3 can be divided into six (2×3) rectangles (3-1 to 3-6).

Moreover, as described above, since the region 1 can be divided into three shot figures in the y direction by the maximum shot size and the height L2 has already been known, the remaining length in the height direction (y direction) can be obtained. Therefore, by halving the remaining length in the height direction (y direction), the length in the y direction of each of the regions 5, 7, 8, 9, 10, 11, and 12 can be obtained. Since isosceles triangles are configured at the right and left of the isosceles trapezoid, when the length in the y direction of the isosceles triangle is known, the width in the x direction can be obtained. Therefore, isosceles triangles (7-1, 8-1) can be configured in the regions 7 and 8 at the right and left in the lower row obtained by halving the remaining length in the height direction (y direction). Similarly, isosceles triangles (11-1, 12-1) can be configured in the regions 11 and 12 at the right and left in the upper row obtained by halving the remaining length in the height direction (y direction).

Next, based on “4”, the region in the lower row obtained by halving the remaining length in the height direction (y direction) can be divided into four figures in the x direction by the maximum shot size. Therefore, the region 5 can be divided into four (4×1) rectangles (5-1 to 5-4). Based on the widths in the x direction of the regions 5, 7, and 8, the remaining width in the x direction in the lower row can be obtained. The example of FIG. 7 shows the case where there is no remaining width.

Next, based on “1”, it can be understood that the region in the upper row obtained by halving the remaining length in the height direction (y direction) can be divided by the maximum shot size in the x direction into one shot figure. Therefore, the region 9 can be divided into one (1×1) rectangle (9-1). Based on the widths in the x direction of the regions 9, 11, and 12, the remaining width in the x direction in the upper row can be obtained. Then, the width in the x direction of the region 10-1 or 10-2 can be calculated by halving the remaining width in the x direction in the upper row.

Since the length in the y direction of the region in the upper row has already been obtained, the region 10 can be divided into two (2×1) rectangles (10-1, 10-2).

As described above, based on “0x07, 3, 4, 4, 1” of the shot division image information shown in FIG. 7B, it is possible to specify each shot figure made by dividing the isosceles trapezoid shown in FIG. 7A into shot figures.

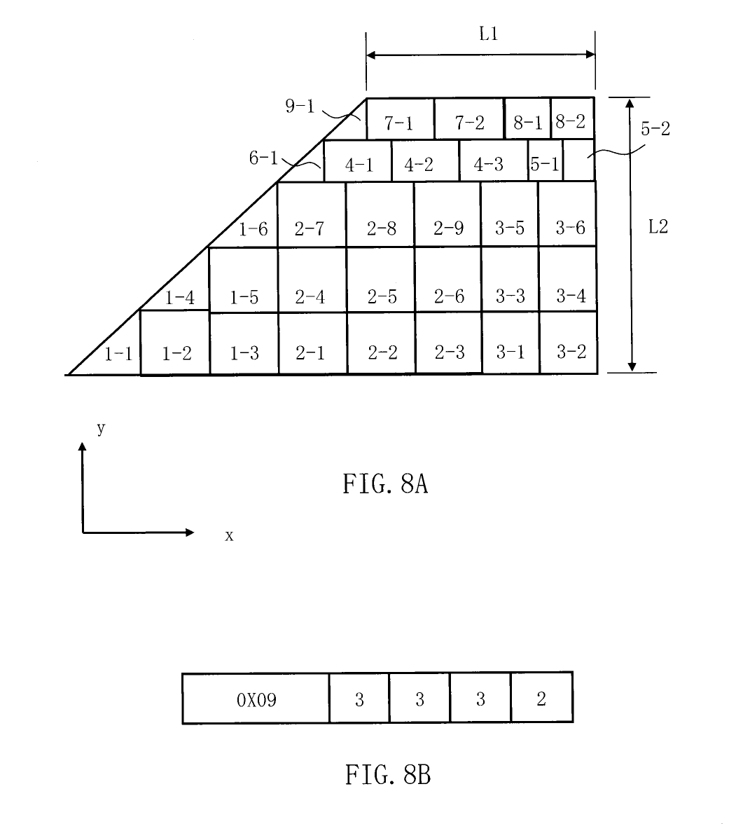

FIGS. 8A and 8B are schematic diagrams showing another example of an original figure to be divided into shot figures and shot division image information thereon according to Embodiment 3. FIG. 8A shows, as an example, a trapezoid whose data amount tends to be large such as a one-legged trapezoid composed of an oblique side connected at an angle of 45 degrees to the base (lower base) and another oblique side connected at an angle of 90 degrees to the base (lower base). In this case, the trapezoid whose lower and upper bases are in the x direction and height is in the y direction is shown as an example. FIG. 8B shows an example of shot division image information on this trapezoid. The rule of shot division image information herein differs from those of Embodiments 1 and 2.

As shown in FIG. 8B, shot division image information is generated with respect to shot figures made by dividing a figure. The shot division image information according to Embodiment 3 is generated based on the following rule, as shown in FIG. 8A. The shot division image information is defined in the x direction (the first direction) from the reference position (lower left vertex position) of a figure pattern concerned, in order of a figure code indicating the shape of the original figure pattern to be divided, and then, with respect to the region 1 where an isosceles triangle shown in FIG. 8A can be configured, the number of shot figures in the x direction having been divided by the maximum shot size in the x and y directions and continuously arranged, with respect to the region 2 where a quadrangle (rectangle or square) shown in FIG. 8A can be configured, the number of shot figures in the x direction having been divided by the maximum shot size in the x and y directions and continuously arranged, with respect to the region 4 which is the (lower) region obtained by halving the remaining length in the height direction (y direction) of the trapezoid shown in FIG. 8A, the number of shot figures in the x direction having been divided by the maximum shot size in the x direction and continuously arranged, and with respect to the region 7 which is the other (upper) region obtained by halving the remaining length in the height direction (y direction) of the trapezoid shown in FIG. 8A, the number of shot figures in the x direction having been divided by the maximum shot size in the x direction and continuously arranged.

If the x and y directions are reversed with respect to the arrangement direction of the trapezoid, what is necessary is just to read the x and y directions conversely for the shot division image information described above. Therefore, the shot division image information on the one-legged trapezoid of FIG. 8A is defined as follows as shown in FIG. 8B: “0x09” indicating a one-legged trapezoid having an oblique side at the left is defined as the figure code of the original figure pattern to be divided. Next, “3” is defined as the number of shot figures in the x direction out of the shot FIGS. 1-1 to 1-6) having been divided by the maximum shot size in the x and y directions and continuously arranged in the region 1. Next, “3” is defined as the number of shot figures in the x direction out of the shot FIGS. 2-1 to 2-9) having been divided by the maximum shot size in the x and y directions and continuously arranged in the region 2. Next, “3” is defined as the number of shot figures in the x direction out of the shot FIGS. (4-1 to 4-3) having been divided by the maximum shot size in the x direction and continuously arranged in the region 4. Lastly, “2” is defined as the number of shot figures in the x direction out of the shot FIGS. 7-1, 7-2) having been divided by the maximum shot size in the x direction and continuously arranged in the region 7.

As described above, when a figure pattern is a trapezoid composed of an oblique side connected at an angle of 45 degrees to the base (lower base) and another oblique side connected at an angle of 90 degrees to the base (lower base), the shot division image information can be defined by specifying therein the figure code indicating a trapezoid and the number of shot figures having been divided, according to the pre-set order, by the maximum shot size with respect to one of the directions x and y. Now, the steps of discriminating each shot figure based on the shot division image information will be explained. First, as to the one-legged trapezoid, the figure code “0x09”, the upper base (L1), and the height (L2) have already been defined in the original pattern data.

The following can be understood from the shot division image information. Based on the figure code “0x09”, it can be understood that the figure concerned is a one-legged trapezoid having an oblique side at the left. Next, based on “3”, the figure pattern can be divided in the x direction (the first direction) from the reference position (lower left vertex position) of the figure pattern concerned into three figures at the bottom part by the maximum shot size. Since the oblique side is inclined by 45 degrees in the one-legged trapezoid which has an oblique side at the left as described above, the figure can also be similarly divided into three shot figures in the y direction by the maximum shot size. Therefore, the region 1 can be divided into three isosceles triangles (1-1, 1-4, 1-6) along the oblique side, two squares (1-2, 1-3) in the x direction next to the isosceles triangle (1-1), and one square (1-5) in the x direction next to the isosceles triangle (1-4).

Next, based on “3”, it can be understood that the region 2 can be divided into three shot figures in the x direction by the maximum shot size. As described above, since the region 1 can be divided into three shot figures in the y direction by the maximum shot size, it is also understood that the region 2 can be divided into three figures in the y direction by the maximum shot size. Therefore, the region 2 can be divided into nine (3×3) squares (2-1 to 2-9).

Next, since the length L1 of the upper base and the height L2 have already been known, the length of the lower base can be obtained. Therefore, one half of the width in the x direction of the region 3 can be obtained by excluding the regions 1 and 2 and halving the remaining width in the x direction. Moreover, as described above, since the region 1 can be divided into three shot figures in the y direction by the maximum shot size, the region 3 can also be divided into three figures in the y direction by the maximum shot size. Therefore, the region 3 can be divided into six (2×3) rectangles (3-1 to 3-6).

Moreover, as described above, since the region 1 can be divided into three shot figures in the y direction by the maximum shot size and the height L2 has already been known, the remaining length in the height direction (y direction) can be obtained. Therefore, by halving the remaining length in the height direction (y direction), the length in the y direction of each of the regions 4, 5, 6, 7, 8, and 9 can be obtained. Since an isosceles triangle is configured at the left of the one-legged trapezoid which has an oblique side at the left, when the length in the y direction of the isosceles triangle is known, the width in the x direction can be obtained. Therefore, one isosceles triangle (6-1) can be configured in the region 6 at the left in the lower row obtained by halving the remaining length in the height direction (y direction). Similarly, one isosceles triangle (9-1) can be configured in the region 9 at the left in the upper row obtained by halving the remaining length in the height direction (y direction).

Next, based on “3”, it can be understood that the region in the lower row obtained by halving the remaining length in the height direction (y direction) can be divided by the maximum shot size in the x direction into three figures. Therefore, the region 4 can be divided into three (3×1) rectangles (4-1 to 4-3).

Next, based on the widths in the x direction of the regions 4 and 6, the remaining width in the x direction in the lower row obtained by halving the remaining length in the height direction (y direction) can be calculated. Therefore, one half of the width in the x direction of the region 5 can be obtained by halving the remaining width in the x direction in the lower row. Since the length in the y direction of the region in the lower row obtained by halving the remaining length in the height direction (y direction) has already been obtained, the region 5 can be divided into two (2×1) rectangles (5-1 to 5-2).

Next, based on “2”, it can be understood that the region in the upper row obtained by halving the remaining length in the height direction (y direction) can be divided by the maximum shot size in the x direction into two shot figures. Therefore, the region 7 can be divided into two (2×1) rectangles (7-1, 7-2). Based on the widths in the x direction of the regions 7 and 9, the remaining width in the x direction in the upper row can be obtained. Then, the width in the x direction of the region 8-1 or 8-2 can be calculated by halving the remaining width in the x direction in the upper row. Since the length in the y direction of the region in the upper row has already been obtained, the region 8 can be divided into two (2×1) rectangles (8-1, 8-2).

As described above, based on “0x09, 3, 3, 3, 2” of the shot division image information shown in FIG. 8B, it is possible to specify each shot figure made by dividing the one-legged trapezoid having an oblique side at the left shown in FIG. 8A into shot figures.

FIGS. 9A and 9B are schematic diagrams showing another example of an original figure to be divided into shot figures and shot division image information thereon according to Embodiment 3. FIG. 9A shows, as an example, a parallelogram, whose data amount tends to be large, such as a parallelogram having 45 degree angles. In this case, the base of the parallelogram is in the x direction and the height is in the y direction, as an example. FIG. 9B shows an example of shot division image information on the parallelogram having 45 degree angles. The rule of shot division image information herein differs from those of Embodiments 1 and 2.

As shown in FIG. 9B, shot division image information is generated with respect to shot figures made by dividing a figure. The shot division image information according to Embodiment 3 is generated based on the following rule, as shown in FIG. 9A. The shot division image information is defined in the x direction (the first direction) from the reference position (lower left vertex position) of a figure pattern concerned, in order of a figure code indicating the shape of the original figure pattern to be divided, the number of shot figures in the x direction having been divided by the maximum shot size in the x direction and continuously arranged, the number of shot figures in the y direction having been divided by the maximum shot size in the y direction and continuously arranged, and with respect to the region 5 which is the (e.g., lower) region obtained by halving the remaining length in the height direction (y direction) of the parallelogram shown in FIG. 9A, the number of shot figures in the x direction having been divided by the maximum shot size in the x direction and continuously arranged.

If the x and y directions are reversed with respect to the arrangement direction of the parallelogram, what is necessary is just to read the x and y directions conversely for the shot division image information described above. Therefore, the shot division image information on the parallelogram having 45 degree angles of FIG. 9A is defined as follows as shown in FIG. 9B: “0x0F” indicating a parallelogram having 45 degree angles is defined as the figure code of the original figure pattern to be divided. Next, “5” is defined as the number of shot FIGS. 1-1 to 1-5) in the x direction having been divided by the maximum shot size in the x direction and continuously arranged. Next, “2” is defined as the number of shot figures in the y direction having been divided by the maximum shot size in the y direction and continuously arranged. Lastly, “4” is defined as the number of shot figures in the x direction having been divided by the maximum shot size in the x direction and continuously arranged in the region which is the (e.g., lower) region made by halving the remaining length in the height direction (y direction).

As described above, when a figure pattern is a parallelogram having 45 degree angles, the shot division image information can be defined by specifying therein in order the figure code indicating a parallelogram having 45 degree angles, the number of shot figures having been divided by the maximum shot size in the x direction, and the number of shot figures having been divided by the maximum shot size in the y direction. Now, the steps of discriminating each shot figure based on the shot division image information will be explained. First, as to the parallelogram having 45 degree angles, the figure code “0x0F”, the base (L1), and the height (L2) have already been defined in the original pattern data.

The following can be understood from the shot division image information. Based on the figure code “0x0F”, it can be understood that the figure concerned is a parallelogram having 45 degree angles. Next, based on “5”, the figure pattern can be divided in the x direction (the first direction) from the reference position (lower left vertex position) of the figure pattern concerned into five figures by the maximum shot size. Next, based on “2”, the figure pattern can be divided in the y direction (the second direction) from the reference position (lower left vertex position) of the figure pattern concerned into two figures by the maximum shot size. Therefore, the region 1 can be divided into two isosceles triangles (1-1, 1-6) along the oblique side, four squares (1-2, 1-3, 1-4, 1-5) in the x direction next to the isosceles triangle (1-1), and four squares (1-7, 1-8, 1-9, 1-10) in the x direction next to the isosceles triangle (1-6).

Moreover, in the parallelogram having 45 degree angles, an oblique side having a 45 degree angle exists also at the opposite side of the reference position of the figure pattern concerned. Therefore, similarly, it can be divided into two isosceles triangles (4-1, 4-2) along with the oblique side.

Next, since the base length L1 and the height L2 have already been known, one half of the width in the x direction of the region 2 or 3 can be obtained by excluding the region 1 and halving the remaining width in the x direction. Moreover, since the length in the y direction of the region 1 is the maximum shot size, the length in the y direction of the region 2 or 3 can be known. Therefore, the region 2 can be divided into two (2×1) rectangles (2-1, 2-2). Similarly, the region 3 can be divided into two (2×1) rectangles (3-1, 3-2).

Moreover, as described above, since the figure pattern can be divided into two figures in the y direction by the maximum shot size and the height L2 has already been known, the remaining length in the height direction (y direction) can be obtained. Therefore, by halving the remaining length in the height direction (y direction), the length in the y direction of each of the regions 5 to 12 can be obtained. In the parallelogram having 45 degree angles, isosceles triangles are configured at the right and left. Then, as to the isosceles triangle, when the length in the y direction is known, the width in the x direction can be obtained.

Therefore, it can be understood that one isosceles triangle (7-1 or 8-1) is configured respectively in the regions 7 and 8 at the right and left in the lower row obtained by halving the remaining length in the height direction (y direction). Similarly, one isosceles triangle (11-1 or 12-1) can be configured respectively in the regions 11 and 12 at the right and left in the upper row.

Next, based on “4”, the region in the lower row obtained by halving the remaining length in the height direction (y direction) can be divided into four figures in the x direction by the maximum shot size. Therefore, the region 5 can be divided into four (4×1) rectangles (5-1 to 5-4). Similarly, the region in upper row obtained by halving the remaining length in the height direction (y direction) can be divided into four figures in the x direction by the maximum shot size. Therefore, the region 9 can be divided into four (4×1) rectangles (9-1 to 9-4).

Next, based on the widths in the x direction of the regions 5 and 7, the remaining width in the x direction in the lower row obtained by halving the remaining length in the height direction (y direction) can be calculated. Therefore, one half of the width in the x direction of the region 6 can be obtained by halving the remaining width in the x direction in the lower row. Since the length in the y direction of the region in the lower row obtained by halving the remaining length in the height direction (y direction) has already been obtained, the region 6 can be divided into two (2×1) rectangles (6-1 to 6-2).

Next, based on the widths in the x direction of the regions 9 and 11, the remaining width in the x direction in the upper row obtained by halving the remaining length in the height direction (y direction) can be calculated. Therefore, one half of the width in the x direction of the region 10 can be obtained by halving the remaining width in the x direction in the upper row. Since the length in the y direction of the region in the upper row obtained by halving the remaining length in the height direction (y direction) has already been obtained, the region 10 can be divided into two (2×1) rectangles (10-1 to 10-2).

As described above, based on “0x0F, 5, 2, 4” of the shot division image information shown in FIG. 9B, it is possible to specify each shot figure made by dividing the parallelogram having 45 degree angles shown in FIG. 9A into shot figures.

That is, in the shot division image information according to Embodiment 3, there is not defined information on the figure size, etc. and the number of shot figures which are not to be divided by the maximum shot size, but there is defined information on a figure code indicating the shape of a figure pattern concerned and the number of shot figures divided by the maximum shot size with respect to at least one direction of the first direction (for example, x direction) and the second direction (for example, y direction) perpendicular to the first direction, which are defined according to a pre-set order. Thereby, the amount of data of shot division image information on each figure can be reduced. For example, if the isosceles trapezoid shown in FIG. 7A is defined according to the method of shot division image information described in Embodiment 1, 10 bytes is enough as the amount of data for defining the shot division image information shown in FIG. 7B though 150 bytes have usually been needed. Similarly, the shot division image information of FIG. 8B on the one leg trapezoid shown in FIG. 8A can be defined by 10 bytes. Similarly, the shot division image information of in FIG. 9B on the parallelogram shown in FIG. 9A can be defined by 8 bytes.

That is, it is possible to greatly reduce the amount of data by using the shot division image information described above. Further, it is possible to greatly reduce the processing time when the shot division image information is shared among figures having the same figure code and figure size.

In addition, with respect to a quadrangle, such as a rectangle and a square, an isosceles right triangle, etc., it is also preferable to define shot division image information by using a figure code indicating the shape of the figure pattern concerned.

Referring to specific examples, Embodiments have been described above. However, the present invention is not limited to these examples.

While the apparatus structure, control method, etc. not directly necessary for explaining the present invention are not described, some or all of them may be suitably selected and used when needed. For example, although description of the structure of a control unit for controlling the writing apparatus 100 is omitted, it should be understood that some or all of the structure of the control unit is to be selected and used appropriately when necessary.

In addition, any other charged particle beam writing apparatus and a method thereof that include elements of the present invention and that can be appropriately modified by those skilled in the art are included within the scope of the present invention.

Additional advantages and modification will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A charged particle beam writing apparatus comprising:
a storage unit configured to store chip data in which there is defined each figure pattern data indicating a shape, alignment coordinates, and a size of each of a plurality of figure patterns included in a chip;
a shot division image information generation unit configured to input the each figure pattern data in the chip data, and for the each of the plurality of figure patterns, when the each of the plurality of figure patterns is divided into a plurality of shot figures each having a size to be irradiated with one shot of a charged particle beam, to generate shot division image information for discriminating a size of each of the plurality of shot figures and an arrangement position in the each of the plurality of figure patterns of the each of the plurality of shot figures;
an allotting processing unit configured, by using the shot division image information and information on alignment coordinates of the each of the plurality of figure patterns, to allot the each of the plurality of shot figures to be arranged in each of a plurality of mesh regions virtually divided by a predetermined size from a reference position different from an end portion of a figure pattern concerned in a chip region concerned indicated by the chip data;
a shot number calculation unit configured, for the each of the plurality of mesh regions, to calculate a number of shots of the charged particle beam used when writing inside of a mesh region concerned based on a number of allotted shot figures;
a writing time prediction unit configured to predict a writing time for writing a chip concerned based on the number of shots for the each of the plurality of mesh regions; and
a writing unit configured to write a pattern in the chip concerned on a target workpiece, using the charged particle beam.

2. The apparatus according to claim 1,
wherein, in the shot division image information, a figure code indicating a shape, and a size of the each of the plurality of shot figures, and a number of identical shot figures continuously arranged are defined in order, starting from the reference position of the figure pattern concerned in a first direction, and when reaching the end portion of the figure pattern concerned with respect to the first direction, shifting is performed in a second direction perpendicular to the first direction, and again in the first direction, until all of the plurality of shot figures, which have been made by dividing the figure pattern concerned, are covered.

3. The apparatus according to claim 1,
wherein, in the shot division image information, a figure code indicating a shape of a figure pattern to be divided in the plurality of figure patterns, a number of shot figures having been divided by a maximum shot size and continuously arranged in the plurality of shot figures, and a size of a remaining shot figure in the plurality of shot figures, wherein the remaining shot figure remains with respect to a first direction when excluding the shot figures having been divided by the maximum shot size and continuously arranged, are defined in order in the first direction from the reference position of the figure pattern concerned.

4. The apparatus according to claim 1,
wherein the chip includes a plurality of cells each being configured by at least one figure pattern,
a plurality of divided cell regions in meshes made by virtually dividing a region of each of the plurality of cells by a predetermined size from an end portion of a cell concerned are used as the plurality of mesh regions, and
the allotting processing unit allots, to the each of the plurality of divided cell regions, the each of the plurality of shot figures to be arranged in a divided cell region concerned.

5. The apparatus according to claim 1,
wherein the shot division image information is defined by specifying therein a figure code indicating a shape of the figure pattern concerned and a number of shot figures divided, according to a pre-set order, by a maximum shot size with respect to at least one of a first direction and a second direction perpendicularly to the first direction in the plurality of shot figures.

6. The apparatus according to claim 5,
wherein, when the figure pattern concerned is a trapezoid having two oblique sides connected to a base through a 45 degree angle and a 135 degree angle, the shot division image information is defined by specifying therein the figure code indicating the trapezoid and the number of the shot figures divided, according to the pre-set order, by the maximum shot size with respect to one of x direction and y direction.

7. The apparatus according to claim 5,
wherein, when the figure pattern concerned is a trapezoid composed of an oblique side connected at an angle of 45 degrees to a base and another oblique side connected at an angle of 90 degrees to the base, the shot division image information is defined by specifying therein the figure code indicating the trapezoid and the number of the shot figures divided, according to the pre-set order, by the maximum shot size with respect to one of x direction and y direction.

8. The apparatus according to claim 5,
wherein, when the figure pattern concerned is a parallelogram having 45 degree angles, the shot division image information is defined by specifying therein in order the figure code indicating the parallelogram, the number of the shot figures divided by the maximum shot size with respect to x direction, and the number of the shot figures divided by the maximum shot size with respect to y direction.

9. A charged particle beam writing method comprising:
inputting each figure pattern data in chip data, from a storage unit storing the chip data in which there is defined the each figure pattern data indicating a shape, alignment coordinates, and a size of each of a plurality of figure patterns included in a chip, and generating, for the each of the plurality of figure patterns, when the each of the plurality of figure patterns is divided into a plurality of shot figures each having a size to be irradiated with one shot of a charged particle beam, shot division image information for discriminating a size of each of the plurality of shot figures and an arrangement position in the each of the plurality of figure patterns of the each of the plurality of shot figures;
allotting, by using the shot division image information and information on alignment coordinates of the each of the plurality of figure patterns, the each of the plurality of shot figures to be arranged in each of a plurality of mesh regions virtually divided by a predetermined size from a reference position different from an end portion of a figure pattern concerned in a chip region concerned indicated by the chip data;
calculating, for the each of the plurality of mesh regions, a number of shots of the charged particle beam used when writing inside of a mesh region concerned based on a number of allotted shot figures;
predicting a writing time for writing a chip concerned based on the number of shots for the each of the plurality of mesh regions; and
writing a pattern in the chip concerned on a target workpiece, using the charged particle beam.

10. The method according to claim 9,
wherein, in the shot division image information, a figure code indicating a shape, and a size of the each of the plurality of shot figures, and a number of identical shot figures continuously arranged are defined in order, starting from the reference position of the figure pattern concerned in a first direction, and when reaching the end portion of the figure pattern concerned with respect to the first direction, shifting is performed in a second direction perpendicular to the first direction, and again in the first direction, until all of the plurality of shot figures, which have been made by dividing the figure pattern concerned, are covered.

11. The method according to claim 9,
wherein, in the shot division image information, a figure code indicating a shape of a figure pattern to be divided in the plurality of figure patterns, a number of shot figures having been divided by a maximum shot size and continuously arranged in the plurality of shot figures, and a size of a remaining shot figure in the plurality of shot figures, wherein the remaining shot figure remains with respect to a first direction when excluding the shot figures having been divided by the maximum shot size and continuously arranged, are defined in order in the first direction from the reference position of the figure pattern concerned.

12. The method according to claim 9,
wherein the chip includes a plurality of cells each being configured by at least one figure pattern,
a plurality of divided cell regions in meshes made by virtually dividing a region of each of the plurality of cells by a predetermined size from an end portion of a cell concerned are used as the plurality of mesh regions, and
the each of the plurality of shot figures is allotted to the each of the plurality of divided cell regions in order to be arranged in a divided cell region concerned.

13. The method according to claim 9,
wherein the shot division image information is defined by specifying therein a figure code indicating a shape of the figure pattern concerned and a number of shot figures divided, according to a pre-set order, by a maximum shot size with respect to at least one of x direction and y direction in the plurality of shot figures.

14. The method according to claim 13,
wherein, when the figure pattern concerned is a trapezoid having two oblique sides connected to a base through a 45 degree angle and a 135 degree angle, the shot division image information is defined by specifying therein the figure code indicating the trapezoid and the number of the shot figures divided, according to the pre-set order, by the maximum shot size with respect to one of x direction and y direction.

15. The method according to claim 13,
wherein, when the figure pattern concerned is a trapezoid composed of an oblique side connected at an angle of 45 degrees to a base and another oblique side connected at an angle of 90 degrees to the base, the shot division image information is defined by specifying therein the figure code indicating the trapezoid and the number of the shot figures divided, according to the pre-set order, by the maximum shot size with respect to one of x direction and y direction.

16. The method according to claim 13,
wherein, when the figure pattern concerned is a parallelogram having 45 degree angles, the shot division image information is defined by specifying therein in order the figure code indicating the parallelogram, the number of the shot figures divided by the maximum shot size with respect to x direction, and the number of the shot figures divided by the maximum shot size with respect to y direction.
